(19) United States
(12) Patent Application Publication
(10) Pub. No.: US 2012/0296012 A1
(43) Pub. Date: Nov. 22, 2012

(54) ROOM TEMPERATURE IONIC LIQUID-EPOXY SYSTEMS AS DISPERSANTS AND MATRIX MATERIALS FOR NANOCOMPOSITES

(75) Inventors: Giuseppe R. Palmese, Hainesport, NJ (US); Arianna L. Watters, Glenside, PA (US)

(73) Assignee: DREXEL UNIVERSITY, Philadelphia, PA (US)

(21) Appl. No.: 13/577,395

(22) PCT Filed: Feb. 4, 2011
(86) PCT No.: PCT/US11/23718

§ 371 Date: Aug. 6, 2012

Related U.S. Application Data
(60) Provisional application No. 61/301,519, filed on Feb. 4, 2010.

(51) Int. Cl. C08L 63/00; C08K 3/04; C08K 5/20; C08K 5/1515; C08K 3/30; C08L 1/00; C08L 63/02; C08L 63/04; C08K 3/34; C08K 3/22; B82Y 30/00

(52) U.S. Cl. 523/427; 523/400; 523/466; 523/468; 523/456; 523/457; 523/448; 977/742

(57) ABSTRACT

Formulations containing a mixture of an epoxy resin and an ionic liquid or an adduct of an epoxy resin and an ionic liquid which may initiate curing of the epoxy resin, the mixture having nano-materials dispersed or dissolved therein. These formulations can be used for the preparation of nanocomposites. Methods of preparing nanocomposites by curing a dispersion of nano-materials in a mixture of an epoxy resin and an ionic liquid or an adduct of an epoxy resin and an ionic liquid which may initiate curing of the epoxy resin. Nanocomposites comprising a cured product formed by curing an epoxy resin with an ionic liquid or an adduct of an epoxy resin and an ionic liquid having nano-materials dispersed or dissolved therein. Embodiments of the invention permit manufacture of nanocomposites having relatively high fracture toughness, relatively high loadings of nano-materials and the ability to tailor the properties of the nano-composites.

### STATEMENT OF GOVERNMENT INTEREST

This invention was made with government support under Grant W911NF-06-2-0013 awarded by the Army Research Laboratory (ARL). The Government has certain rights in this invention.

### BACKGROUND OF THE INVENTION

1. Field of the Invention

The invention relates to use of ionic liquid-epoxy systems as dispersants and matrix materials for nanocomposites and to nanocomposites prepared from dispersions of nano-materials in ionic liquid-epoxy systems.

2. Brief Description of the State of the Art

Epoxy resin chemistry has been widely used in applications such as advanced composites, protective coatings, and adhesives which make use of their infusibility, solvent and crack resistance when cured. The formation of such a cured network structure is achieved using a variety of curing agents which have been the focus of a substantial amount of research. Ellis, B., ed., Chemistry and Technology of Epoxy Resins, 1993, London; New York: Blackie Academic & Professional. An area of interest is the synthesis of one-pot formulations that are thermally latent at room temperature but react at elevated temperatures, exhibiting long term storage stability. Examples of possible initiators include organophosphorus compounds (Yie-Shun Chiu, Y.-L. L., Wen-Lung Wei, Wen-Yu Chen, “Using diethylphosphites as thermally latent curing agents for epoxy compound,” Journal of Polymer Science Part A: Polymer Chemistry, 2003. 41(3): p. 432-440), metal complexes (Zhuqing Zhang, C. P. W., “Study on the catalytic behavior of metal acetylacetonates for epoxy curing reactions,” Journal of Applied Polymer Science, 2002. 86(7): p. 1572-1579), imidazoles (Heise, M. S. and G. C. Martin, “Curing mechanism and thermal properties of epoxy-imidazole systems,” Macromolecules, 1989. 22(1): p. 99-104), or dicyandiamide Amdouni, N., et al., “Epoxy networks based on dicyandiamide: effect of the cure cycle on viscoelastic and mechanical properties,” Polymer, 1990. 31(7): p. 1245-1253 based formulations, all of which have advantages and drawbacks.

Certain room temperature ionic liquids (RTILS) are capable of initiating the homopolymerization of epoxy resins resulting in highly cross-linked thermosets which is in some ways similar to another recent report, Krzysztof Kowalczyk, T. S., “Ionic liquids as convenient latent hardeners of epoxy resin,” Polimery, 2003. 48(11-12): p. 833-835. However, the degree to which reaction occurs, the mechanism of reaction and resulting mechanical properties remain unclear, and initiation might be through a mechanism similar to BF₃-amine complexes.

Other RTILs used as curing agents or initiators for epoxy resins are described in Rahmathullah, A. M., et al., “Room Temperature Ionic Liquids (RTILs) as novel latent curing agents and additives for epoxy resins”, Proceedings of the SAMPE Annual Meeting, Baltimore, Md. (2007) and Rahmathullah, A. M., et al., “Room Temperature Ionic Liquids as thermally latent initiators for polymerization of epoxy resins”, Macromolecules, (2009), 42 (9), p. 3219-3221. U.S. Patent application publication no. US 2009/0030158 A1 discloses resin compositions which may contain epoxy groups formulated with various ionic liquids which can be used to cure the resins to form cured products. The cured products may be used as adhesives, sealing agents and casting materials.

The uses of ionic liquids (ILs) have been reviewed in Winterton, N., “Solubilization of polymers by ionic liquid,” Journal of Materials Chemistry, 2006. 16: p. 4281-4293 and are advantageous because of their low or almost-negligible vapor pressure, extremely low viscosities, and highly tunable “designer” structures while potentially being an environmentally benign chemical, Jonathan G. Huddleston, et al, “Characterization and comparison of hydrophilic and hydrophobic room temperature ionic liquids incorporating the imidazolium cation,” Green Chemistry, 2001, 3: p. 156-164, which means that problems associated with initiator dispersion, toxicity and possibly even cost are substantially mitigated.

Accordingly, it is an object of certain embodiments of the present invention to provide curable materials which can be cured to form nanocomposites with advantageous properties such as high fracture toughness and relatively high loadings of nano-materials therein.

It is another object of certain embodiments of the present invention to provide curable matrices which have the ability to disperse a wide variety of nano-materials to provide flexibility in the manufacture of nanocomposites.

It is a still further object of certain embodiments of the present invention to provide nanocomposites which can be tailored to specific uses by variations in the types and amounts of materials that form the curable composition used to make the nanocomposites.

### SUMMARY OF THE INVENTION

In a first aspect, the present invention relates to formulations containing a mixture of an epoxy resin and an ionic liquid or an adduct of an epoxy resin and an ionic liquid which may initiate curing of the epoxy resin, the mixture having nano-materials dispersed therein. These formulations can be used for the preparation of nanocomposites.

In a second aspect, the present invention relates to a method of preparing nanocomposites by curing a dispersion of nano-materials in a mixture of an epoxy resin and an ionic liquid or an adduct of an ionic liquid with an epoxy resin which may initiate curing of the epoxy resin.

In a third aspect, the present invention relates to nanocomposites comprising a cured product formed by curing an epoxy resin with an ionic liquid or an adduct of an epoxy resin and an ionic liquid having nano-materials dispersed therein.

In a fourth aspect, any of the foregoing formulations, methods or nanocomposites may be prepared or carried out in the presence of an additional ionic liquid which is non-reactive in that it does not function as a curing agent for the epoxy resin.

Certain embodiments of the invention permit the manufacture of nanocomposites having relatively high fracture toughness, relatively high loadings of nano-materials, as well as the ability to tailor the properties of the nano-composites to specific uses.

### BRIEF DESCRIPTION OF THE DRAWINGS

FIG. 1 is a plot of loss modulus versus temperature for EPONYM 828 thermosets initiated by (□) 3.20, () 4.5, (+) 6.5, (◯) 7.8 and (▪) 9.9 weight percent emimdcn.

FIG. 2 is a plot of heat flow versus temperature for EPON™ 828 with (a) 1, (b) 9, and (c) 15 weight percent emimdcn reacted at 2° C./min in a DSC. Curves are plotted as exotherm down.

FIG. 3 is a plot of (□) Tg at tan delta maximum and (◯) storage modulus at (Tg+30° C.) as a function of emimdcn initiator concentration.

FIG. 4 is a plot of Tg of EPON™ 828 cured with emimdcn versus weight percent emimdcn as obtained from DSC after cure at a scan rate of 2° C./min.

FIG. 5 is a plot showing Tg (filled markers) and storage modulus at 50° C. (open markers) for epoxy-amine thermosets synthesized in the presence of (circles) emim ethylsulfate and (squares) emim tosylate.

FIG. 6 shows the dynamic mechanical behavior, represented by storage modulus and loss modulus, for various blends of emimdcn and Epon™ 828.

FIG. 7 shows the influence of the concentration of ionic liquid on the glass transition temperature and rubber modulus (E′).

FIG. 8 is scanning electron micrograph image of the fracture surface of a nanocomposite of the invention including nanotubes therein showing the nanotubes protruding from the surface of the material at a magnification level of 50×.

FIG. 9 is a scanning electron micrograph image of the carbon nanotube-containing nanocomposite of FIG. 8 at a magnification level of 2000×.

FIG. 10 is a scanning electron micrograph image showing the fracture surface morphology of the matrix material of the nanocomposite of FIGS. 8-9 without the nanotubes prepared from 9 wt % emimdcn and Epon™ 836 at a magnification level of 1000× for comparison purposes.

FIG. 11 shows the loss modulus of nanocomposites made according to Examples 6-10.

FIG. 12 shows the loss modulus of nanocomposites made according to Examples 11-15.

FIG. 13 shows the storage modulus of nanocomposites made according to examples 4, 9, 14, 19 and F, respectively.

FIG. 14 shows the results of a gas phase chromatography investigation of the PGE epoxy resin cured with excess emimdcn demonstrating adduct formation.

FIG. 15 shows isothermal conversion profiles obtained by differential scanning calorimetry for a reaction of 1.4 mol of emimdcn per mole of PGE epoxy resin.

FIG. 16 shows the reaction exotherm measured by DSC of a mixture comprised by 50 wt % Epon™ 828 DGEBA and 50 wt % previously reacted adduct of 1:1 molar ratio of PGE:emimdcn.

FIG. 17 shows a DMA plot for Example 25, a nanocomposite having the composition: Epon™ 828 6.3 g, emimdcn 2.7 g, and CA1 1 g.

FIG. 18 shows a DMA plot for Example 26, a nanocomposite having the composition Epon™ 828 6.44 g, emimdcn 2.76 g, and CA1 0.8 g.

FIGS. 19A-19B show the elasticity of the nanocomposite of Example 27.

FIG. 20 shows the loss modules of nanocomposites made according to Examples 1-5.

FIG. 21 is a plot of particle size versus sonication time for the silica-dispersion of Example 28.

FIG. 22 shows a plot of storage and loss modulus versus temperature for the silica nanocomposite of Example 28.

FIG. 23 shows SEM images of the fractured silica nanocomposite of Example 28.

FIG. 24 is an x-ray diffraction plot of the scatting angle versus the scattering intensity for the graphene dispersion of Example 29.

FIG. 25 shows a plot of sonication time versus the ratio of peak at a 27° scattering angle peak area to amorphous peak area for the graphene dispersion of Example 29.

FIG. 26 shows a plot of storage and loss modulus versus temperature for the graphene nanocomposite of Example 29.

FIG. 27 shows SEM images of the fractured graphene nanocomposite of Example 29.

FIG. 28 shows a plot of storage and loss modulus versus temperature for the silica and graphene nanocomposite of Example 30.

FIG. 29 shows images of 5 wt % Cloisite™ solutions in emimdcn containing a. Cloisite™ 10A, b. Cloisite™ 15A, c. Cloisite™ 20A, d. Cloisite™ 25A, e. Cloisite™ 30B, f. Cloisite™ 93A, g. Cloisite™ Na⁺.

FIG. 30 shows images of 5 wt % Cloisite™ solutions in emim EtSO₄ containing a. Cloisite™ 10A, b. Cloisite™ 20A, c. Cloisite™ 25A, d. Cloisite™ 30B, e. Cloisite™ 93A, f. Cloisite™ Na⁺.

FIG. 31 shows images of 1 wt % Cloisite™ in DGEBA and PACM containing a. Cloisite™ 30B, b. Cloisite™ 93A, c. Cloisite™ Na⁺.

FIG. 32 shows an image of a cured composition of 21 wt % DCN/Cloisite™ 93A in DGEBA.

FIG. 33 shows images of cured 21 wt % Cloisite™/emim EtSO₄ in DGEBA and PACM containing a. Cloisite™ 10A, b. Cloisite™ 30B, c. Cloisite™ 93A, d. Cloisite™ Na⁺.

FIG. 34 shows images of cured 1 wt % Cloisite™ in DGEBA and PACM containing a. Cloisite™ 30B, b. Cloisite™ 93A, c. Cloisite™ Na⁺.

### DETAILED DESCRIPTION OF THE PREFERRED EMBODIMENTS

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

It must be noted that as used herein and in the appended claims, the singular forms “a”, “an”, and “the” include plural references unless the context clearly dictates otherwise. As well, the terms “a” (or “an”), “one or more” and “at least one” can be used interchangeably herein. It is also to be noted that the terms “comprising”, “including”, and “having” can be used interchangeably.

The term “resin” as used herein means a polymer precursor compound capable of giving a three-dimensional network structure in the presence of a suitable reagent, and for example, it includes epoxy resin. In this description, the polymer precursor compound and a composition comprising it are referred to as “resin” and “resin composition”, respectively; and their polymerized and cured products are referred to as “cured products”.

The term “ionic liquid” (IL) generally refers to a salt comprising an anion and a cation As used herein, the term, “ionic liquid” refers to a salt comprising an anion and a cation and capable of melting at a temperature falling within a range not higher than the curing temperature of the resin. Preferably, the ionic liquid is a molten salt at an ambient temperature comprising an anion and a cation. Room temperature ionic liquids (RTILs) are ionic liquids which have melting points below room temperature, i.e. (<23° C.). RTILs are characterized by being non-volatile, they typically have negligible vapor pressure, are typically non-flammable and have a high thermal stability. In addition, RTILs may exhibit a wide temperature range for liquid phase of up to about 300° C. RTILs are highly solvating, yet non-coordinating and make good solvents for many organic and inorganic materials. RTILs also have an adjustable pH. As a result of one or more of these characteristic properties, RTILs may be used as modifiers for cross-linked polymers, as well as latent curing agent for epoxies.

In the composition of the invention, it is desirable that the ionic liquid uniformly dissolves in the epoxy resin at or below the curing temperature, and from the viewpoint of readily preparing the composition, the melting point of the ionic liquid is preferably lower than an ambient temperature.

The cation to constitute the ionic liquid includes ammonium cations such as an imidazolium ion, a piperidinium ion, a pyrrolidinium ion, a pyrazolium ion, a guanidinium ion, a pyridinium ion; phosphonium cations such as a tetrabutylphosphonium ion, a tributylhexylphosphonium ion; and sulfonium cations such as a triethylsulfonium ion. Suitable cations may include, for example, 1-ethyl-3-methyl-imadazolium, 1-hexyl-3-methyl-imidazolium, butylmethylpyrrolidinium, and cyclohexyltrimethylammonium. The most preferred cations are imidazolium cations.

The anion to constitute the ionic liquid includes, for example, alkyl sulfate anions such as ethyl sulfate, tosylate anions, tetrafluoroborate ion, dicyanamide anions, bis(trifluoromethylsulfonyl) imide anions, and halide anions such as a fluoride ion, a chloride ion, a bromide ion, and an iodide ion. The preferred anions are dicyanimide and chloride anions.

Ionic liquids may be prepared in any suitable, conventional manner. For producing the ionic liquid, an anion exchange method that comprises reacting a precursor comprising a cation moiety such as an alkylimidazolium, alkylpyridinium, alkylammonium or alkylsulfonium ion and a halogen-containing anion moiety, with NaBF4, or the like, can be employed. Alternatively, an acid ester method comprising reacting an amine substance with an acid ester to introduce an alkyl group can be employed. Another method involves neutralization of an amine with an organic acid to give a salt. Other suitable, conventional methods may also be employed. In the neutralization method with an anion, a cation and a solvent, the anion and the cation are used both in the equivalent amount, and the solvent in the obtained reaction liquid is evaporated away, and the residue may be used directly as it is; or an organic solvent (e.g., methanol, toluene, ethyl acetate, acetone) may be further added thereto and the resulting liquid may be concentrated.

The ionic liquids may optionally be substituted with one or more groups selected from hydroxyl, cyano, vinyl, acrylate, methacrylate, epoxy, ether and carboxyl groups to provide additional reactivity and/or functionality to the ionic liquids. Ionic liquids substituted with mixtures of such groups may also be employed. Although not specifically defined, the amount of the ionic liquid to be added to the epoxy resins may be any amount which is enough for resin curing.

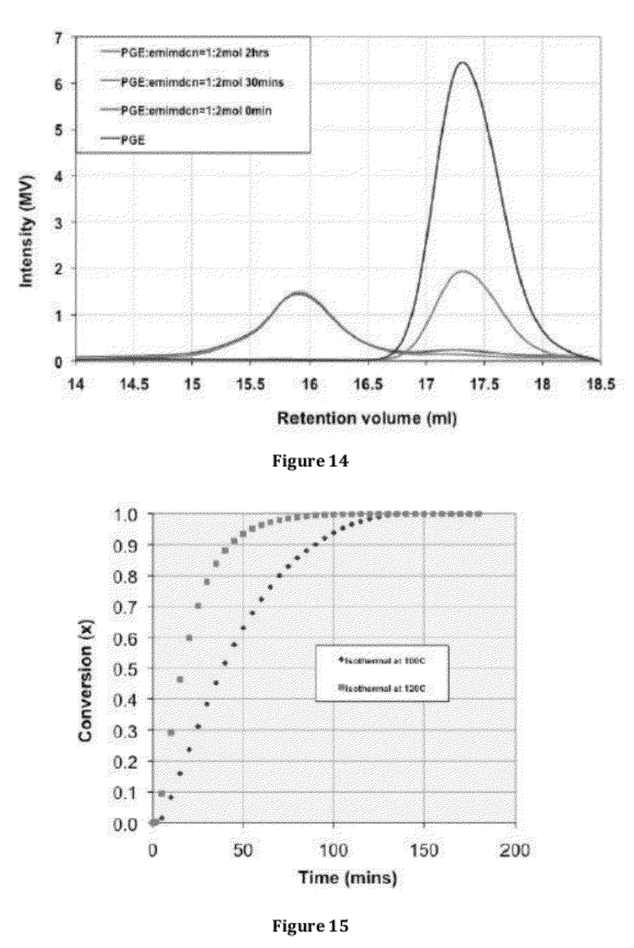

The ratio of IL to epoxy monomer determines the properties of the of the resultant reaction product At high IL to epoxy molar ratios, a mixture of unreacted IL and low molecular weight material, potentially an adduct of the IL with the epoxy, is formed after sufficient heating. An example of adduct formation is shown by the size exclusion chromatograms of the reaction products formed between excess IL emimdcn and Phenyl Glycidyl Ether (PGE) in FIG. 14 which shows the disappearance of the peak associated with PGE and the appearance of a higher molecular weight species after reaction. The reaction between ionic liquid and epoxy can be monitored isothermally using DSC. FIG. 15 shows the isothermal conversion profiles for 100° C. and 120° C. which appear to follow second order kinetics.

As the concentration of epoxy in the initial reaction mixture is increased the viscosity and molecular weight of the product increases and the concentration of unreacted IL decreases. For difunctional epoxies it was observed that as a 1:1 molar ratio of epoxy moiety to IL is approached, a room temperature elastomer is formed (see example). Such materials are potentially crosslinked polymers that may contain unreacted IL as well as low molecular weight reaction products including the adducts described in the previous paragraph. As the concentration of IL is further decreased, cross-linked polymers with glass transition temperature (Tg) above room temperature are produced with little or no remaining unreacted IL. Lower concentrations of IL result in higher Tg and the fracture toughness increases with increasing IL content (see examples)

The properties of the resulting polymers are also dependent on the functionality and type of epoxy. Higher molecular weight epoxies of the same class (DGEBA) produce lower Tg products when cured using the same molar ratio of IL to epoxy moiety. At the same time the higher molecular weight epoxies produce higher toughness polymers. Additionally, monofunctional epoxies result in systems that are flowable and potentially linear and/or branched while epoxies with epoxy functionality greater than 2 will form crosslinked products at lower weight fractions of ionic liquid.

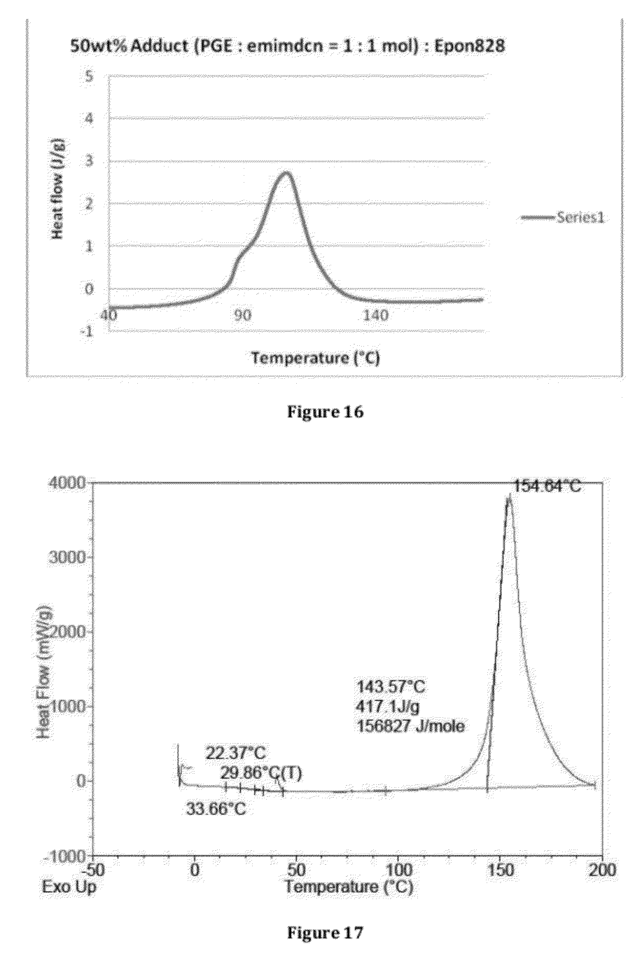

The characteristic double exotherm exhibited by the DCS ramp experiments (multiple figures) suggests a cure process comprised of at least two reaction steps. The formation of an adduct is likely the first step as we have demonstrated its existence by SEC and by the preparation of stable products by the reaction of 1:1 molar ratio mixtures of epoxy to ionic liquid. It has further been found that the addition of such adduct to epoxy results in polymerization. This is shown by the reaction exotherm measured by DSC of a mixture comprised by 50 wt % Epon™ 828 DGEBA and 50 wt % previously reacted adduct of 1:1 molar ratio of PGE:emimdcn of FIG. 16.

The ionic liquid may serve as a curing agent for the epoxy resin, as a curing accelerator when combined with any other curing agent or as a modifier for the epoxy resin. Accordingly, it is desirable that the amount of the ionic liquid is suitably controlled, particularly when the ionic liquid is used for tuning the properties of the cured products. A more preferred range of use of the ionic liquid is at a molar ratio of from 0.1 to 10 moles of ionic liquid per 2 moles of epoxy groups, even more preferably a molar ratio of from 0.2 to 5, still more preferably from 0.2-2.0 is employed.

Thus, the present invention contemplates embodiments where mixtures of nanomaterials and ionic liquids are used to cure epoxy resins. Alternative embodiments form mixtures of nanomaterials, ionic liquids and epoxy resins in order to prepare adducts of the ionic liquid and epoxy resin and then the mixtures containing the adducts are subsequently used to cure epoxy resins.

It is also within the scope of the present invention to include a stoichiometric excess of ionic liquid relative to epoxy resin to ensure the presence of one or both of unreacted ionic liquid or adducts of ionic liquid and epoxy resin in the resultant products. Alternatively, non-reactive ionic liquids which do not cure the epoxy resin may be included in the compositions of the present invention in addition to the reactive ionic liquids used to cure the epoxy resin to ensure the presence of unreacted non-reactive ionic liquid in the cured product. These variations can be used to adjust the properties of the resultant nano-composite such as the fracture toughness and elasticity.

Amounts of 0.01 up to about 20 wt % of a RTIL mixed with epoxy resin exhibits good resin miscibility, long pot life and high thermal stability while being able to initiate cure at elevated temperatures without the associated problems of dispersion and nonhomogenous cure encountered with initiators that are solid at room temperature.

Some ionic liquids are referred to as “hydrophobic” ionic liquids. Hydrophobic ionic liquids are those that form biphasic mixtures in combination with water. However, the miscibility of ionic liquids and water is affected by temperature and thus a biphasic mixture can potentially become completely miscible in water at an elevated temperature. Hydrophilic ionic liquids are those that are completely miscible with water at or below room temperature, i.e. 23° C. All ionic liquids are hygroscopic and thus absorb water from the environment.

The polymers are prepared by mixing suitable ionic liquids with epoxy resins and heating to appropriate temperatures. The ionic liquids can be reactive (i.e. capable of initiating polymerization) and/or non-reactive. If only non-reactive ionic liquids are used then a separate curing agent must be used. Any of a wide variety of epoxy resins may be employed in the present invention. Epoxy resins as referenced herein are resins which include a plurality of glycidyl ether groups, including linear, branched or cyclic epoxies. The glycidyl ether groups allow curing of the epoxy resins to increase the molecular weight of the cured product. In certain embodiments, the epoxy resins are cross-linked using the glycidyl ether groups as reactive cross-linking sites. Additionally non-crosslinked systems can be prepared by using monofunctional epoxy monomers and thus the term “epoxy resin” also includes resins having only a single epoxy group therein. One example of such a monofunctional monomer is phenyl glycidyl ether (PGE). Such monofunctional epoxies can also be used in combination with polyfunctional epoxy monomers like Novolacs and N,N,N′,N′-tetraglycidyl-4,4′-diaminodiphenylmethane (TGDDM). Alternatively, cross-linkable epoxy resins containing only a single epoxy group and one or more non-epoxy cross-linkable groups are also within the scope of epoxy resins in accordance with the present invention.

Exemplary suitable epoxy resins include, but are not limited to, glycidyl ethers of polyphenols such as bisphenol A, bisphenol F, bisphenol AD, alkylene oxides such as ethylene oxide and propylene oxide, epoxidized biphenyls, epoxidized Nafion, catechol, resorcinol; polyglycidyl ethers prepared by reacting a polyalcohol such as glycerin or polyethylene glycol, and epichlorohydrin; glycidyl ether esters prepared by reacting a hydroxycarboxylic acid such as p-hydroxybenzoic acid or β-hydroxynaphthoic acid, and epichlorohydrin; polyglycidyl esters prepared by reacting a polycarboxylic acid such as phthalic acid or terephthalic acid, and epichlorohydrin; and further epoxidated phenol-novolak resins, epoxidated cresol-novolak resins, epoxidated polyolefins, cycloaliphatic epoxy resins and other urethane-modified epoxy resins, to which, however, the invention should not be limited.

Commercial epoxy resin products are, for example, Epon™ 828, Epon™ 836 and Epon™ 1001F, Japan Epoxy Resin's Epikote 828, 1001, 801, 806, 807, 152, 604, 630, 871, YX8000, YX8034, YX4000, Cardula E1 OP; Dai-Nippon Ink Industry's Epiclon 830, 835LV, HP4032D, 703, 720, 726, HP820; Asahi Denka Kogyo's EP4100, EP4000, EP4080, EP4085, EP4088, EPU6, EPR4023, EPR1309, EP49-20; and Nagase ChemteX's Denacol EX411, EX314, EX201, EX212, EX252, EX 111, EX146, EX721, to which, however, the invention should not be limited. A particularly preferred epoxy resin useful in the present invention is the diglycidyl ether of bisphenol A (DGEBA). One or more of these may be used either singly or as combined.

The above-mentioned epoxy resins may have any other functional group than the epoxy group. For example, the epoxy resins may additionally include a hydroxyl group, a vinyl group, an acetal group, an ester group, a carbonyl group, an amide group, an alkoxysilyl group or two or more of such groups including mixtures thereof.

The curable compositions of the present invention include nano-materials dispersed in a mixture of epoxy resin and ionic liquid. A nano-material is any reinforcing material or mixture thereof, which has at least one dimension in the nanometer scale. Suitable nano-materials include, for example, nanoclays including, but not limited to, layered crystalline clays (such as natural or synthetic silicates like aluminium or aluminium-magnesium silicates), graphene and modified graphenes such as graphene oxide, aminated graphene, epoxidized graphene and graphene amide, among others, nano-fibers (such as cellulosic nano-fibers), nano-whiskers (such as cellulosic nano-whiskers), nanotubes (such as carbon or metal oxide nanotubes), nano-platelets (such as carbon nano-platelets), metallic oxides, metallic sulfides, metallic layered double hydroxides, or mixtures thereof. The nanomaterials may include cellulosic materials such as nanocrystalline cellulose.

Nano-materials may be treated with organophilic modifying compounds to enhance physical and chemical interaction between the nano-material and the epoxy group of the epoxy resin. Organophilic modifying compounds are generally known in the art and include such interacting groups as, for example, amines, carboxylics, alcohols, phenols, silanes, organophilic ions, onium ions (ammonium, phosphonium, sulfonium and the like), etc.

The nano-material may be present in the nanocomposite in an amount that is suitable for imparting the desired effect of the nano-material without compromising other properties of the composite necessary for the application in which the nanocomposite is to be used. For example, the nano-material may be used as a reinforcing material, to increase the fracture toughness of the composite, to modify the modulus of the composite and/or to modify the electrical conductivity of the composite. If the amount of nano-material is too low then a sufficient effect will not be obtained, while too much nano-material may hinder exfoliation, compromise the moldability of the nanocomposite and reduce its performance parameters. One skilled in the art can readily determine a suitable amount by experimentation.

The amount of nano-material in the nanocomposite may be from about 0.01 to about 30 volume percent of the total volume of the nanocomposite, about 0.1 to about 20 volume percent of the total volume of the nanocomposite, or about 1 to about 15 volume percent of the total volume of the nanocomposite. A particularly interesting range is from about 0.1 to about 5 volume percent of nano-material in the nanocomposite. In terms of weight, the amount of nano-material in the nanocomposite may alternatively be from about 0.1 to about 40 weight percent based on the total weight of the nanocomposite, or from about 0.2 to about 30 weight percent, or from about 0.5 to about 20 weight percent, or from about 1 to about 10 weight percent.

Layered clays may be mineral or synthetic layered silicates. Phyllosilicates (smectites) are particularly suitable. Typical layered clays include, for example, bentonite, kaolinite, dickite, nacrite, stapulgite, illite, halloysite, montmorillonite, hectorite, fluorohectorite, nontronite, beidellite, saponite, volkonskoite, magadiite, medmontite, kenyaite, sauconite, muscovite, vermiculite, mica, hydromica, phegite, brammalite, celadonite, etc., or a mixture thereof.

Layered clay is a hydrated aluminum or aluminum-magnesium silicate comprised of multiple platelets. The clay may comprise surface groups (e.g., hydroxyl or ionic groups), which render the surface more hydrophilic thereby enhancing the physical and chemical interactions of the clay with the epoxy groups of the epoxy-functionalized graft polymer. Layered clays may be treated with inorganic or organic bases or acids or ions or be modified with an organophilic intercalant (e.g., silanes, titanates, zirconates, carboxylics, alcohols, phenols, amines, onium ions) to enhance the physical and chemical interactions of the clay with the epoxy groups of the epoxy-functionalized graft polymer. When the epoxy-functionalized graft polymer interacts with a layered clay, either the gallery space between the individual layers of a well-ordered multilayer clay is increased and/or the clay aggregates are broken down into smaller stacks due to the strong interface interaction that occurs between the clay surface/modified groups and the epoxy groups of the epoxy-functionalized graft polymer.

Organophilic onium ions are organic cations (e.g., N⁺, P⁺, O⁺, S⁺) which are capable of ion-exchanging with inorganic cations (e.g., Li⁺, Na⁺, K⁺, Ca²⁺, Mg²⁺) in the gallery space between platelets of the layered material. The onium ions are sorbed between platelets of the layered material and ion-exchanged at protonated N⁺, P⁺, O⁺, S⁺ ions with inorganic cations on the platelet surfaces to form an intercalate. Examples of some suitable organophilic onium ions are alkyl ammonium ions (e.g., hexylammonium, octylammonium, 2-ethylhexammonium, dodecylammonium, laurylammonium, octadecylammonium, trioctylammonium, bis(2-hydroxyethyl)octadecyl methyl ammonium, dioctyldimethylammonium, distearyldimethylammonium, stearyltrimethylammonium, ammonium laurate, etc.), and alkyl phosphonium ions (e.g., octadecyltriphenyl phosphonium). Preferably, layered clay may be modified with an onium ion in an amount of about 0.3 to about 3 equivalents of the ion exchange capacity of the clay, more preferably in an amount of about 0.5 to about 2 equivalents. The nanoparticles may include, but are not limited to, carbon nanotubes, carbon nano-platelets, celluloses, and nano-clays. Suitable celluloses include crystalline or microcrystalline cellulose, cotton cellulose, wood pulp cellulose, lignocellulose or cellulosic waste products. These celluloses typically have degrees of polymerization (DPs) of from 30 to 500, preferably from 60 to 150.

Although not necessarily preferred, the nanocomposites of the present invention may also include suitable additives normally used in polymers. Such additives may be employed in conventional amounts and may be added directly to the process during formation of the nanocomposite. Illustrative of such additives are colorants, pigments, carbon black, fibers such as glass fibers, carbon fibers and aramid fibers, fillers, impact modifiers, antioxidants, stabilizers, flame retardants, reheating aids, crystallization aids, oxygen scavengers, plasticizers, flexibilizers, nucleating agents, foaming agents, mold release agents, and combinations thereof. In addition, the nanocomposites of the present invention may include fillers, whiskers and other reinforcing materials, and such materials may be nano-scale or larger, if desired, such as micro-scale or macro-scale. The nanocomposites may be blended with other polymers or foamed by any conventional foaming means, if desired.

Any suitable method for curing may be employed. As a practical matter, to avoid product deterioration and overuse of energy, curing is typically conducted at a temperature of from about 50° C. to about 250° C., more preferably, from about 55° C. to about 200° C., even more preferably, from about 80° C. to about 140° C. Gelling time is preferably up to 120 minutes, more preferably up to 90 minutes, even more preferably up to 60 minutes, still more preferably up to 30 minutes and may be as short as up to 15 minutes. The lowermost limit of the gelling time may be as short as 0.001 seconds, more preferably 0.1 seconds. For relatively instant curing, the upper limit of the gelling time is preferably 15 minutes, more preferably 5 minutes, even more preferably 3 minutes, still more preferably 1 minute, further more preferably 30 seconds.

A particularly preferred method of fabrication of the nanocomposite of the present invention is in situ polymerization. The nanocomposite is formed by mixing epoxy resin monomers and/or oligomers with the nano-material and the ionic liquid, preferably in the absence of a solvent. Subsequent polymerization of the monomer and/or oligomer results in formation of polymer matrix for the nanocomposite.

The composition of the invention is expected to be stored at a temperature of from 20° C. to 40° C. Compositions comprising the resin and the ionic liquid may be stored at these temperatures from 3 hours to 6 months, more preferably, from 3 days to 3 months.

Tunable properties of the composites manufactured by methods in accordance with the present invention include the ability to vary cross-linker ratios, the ability to vary sulfonic acid concentration when using non-reactive RTILs with this functionality, and RTIL concentration. The result of this is the ability to produce composites with tunable thermal, mechanical and conductive properties.

Thermomechanical analyses show that materials with glass transition temperatures (Tg) of ˜200° C. (tan δmax) can be obtained and that the Tg and cross-linking density are dependent on the concentration of the RTIL used. These results have been confirmed by differential scanning calorimetry over a range of RTIL concentrations. Gravimetric analysis also indicates that the hydrophilicity of the cured networks is dependent on the concentration of RTIL used. This demonstrates that a number of important resin properties can be customized by adjustment of the concentration of the RTIL in the process.

The type and/or amount of ionic liquids of the present invention can be selected to allow control of various physicochemical properties of the polymers such as glass transition temperature, cross-linking density, electrical conductivity, thermal stability, specific gravity, heat capacity, and the electrochemical window. Selection of the type and amount of ionic liquid can also be used to tune the vapor pressure, curing temperature, curing time, solvating characteristics, adduct formation, heat of reaction, nucleophilicity, and hydrophilicity during the curing reaction.

The choice of cation and anion for the ionic liquid may be used alone, or in combination with a selection of a specific amount of a particular ionic liquid, to determine physical properties such as melting point, viscosity, density and water solubility. Melting point can be easily modified, as shown in the examples, by structural variation of one of the ions in the ionic liquid or by combining different ions to form the ionic liquid.

The process of the present invention can be employed to prepare composites with high fracture toughness. For example, a fracture toughness of 200-5000 J/m², from 300-3000 J/m², or from 500-2500 J/m² can be achieved by the nanocomposites of the present invention.

Moreover the curing reaction is latent meaning that the mixture of ionic liquid and epoxy resin remains stable at room temperature for prolonged periods of time reacting rapidly once the temperature is raised to a threshold level. The advantages include: (1) the ability of the latent initiator to fully dissolve in epoxy resins, (2) the long term stability of the mixtures of IL and epoxy resins, (3) excellent mechanical properties of resulting composites, particularly fracture toughness, (4) the ability to disperse or dissolve a wide variety of different types of nano-materials due to the relatively high solvating capacity of the ionic liquid component, (5) the ability to incorporate high concentrations of nano-materials into the composites, (6) the ability to prepare composites with reactive or non-reactive free ionic liquid components to provide additional functionality to the composites, such as, for example, ionic conductivity and (7) the composition of the composite can be selected to provide a matrix that is elastomeric or rigid, as desired by, for example, controlling the amount of unreacted ionic liquid present in the composite and/or selection of the epoxy resin. For example, inclusion of unreacted ionic liquid will typically increase the flexibility of the composite. Selection of a linear aliphatic epoxy resin rather than a cyclic or aromatic epoxy resin, will also typically increase the flexibility of the composite.

Standard composite forming techniques may be used to fabricate products from the nanocomposites of the present invention. For example, melt-spinning, casting, vacuum molding, sheet molding, injection molding and extruding, melt-blowing, spun-bonding, blow-molding, overmolding, compression molding, resin transfer molding (RTM), prepregging, thermo-forming, roll-forming and co- or multilayer extrusion may all be used. Examples of products include components for technical equipment, apparatus casings, household equipment, sports equipment, bottles, other containers, components for the electrical and electronics industries, components for the transport industries, and fibers, membranes and films. The nanocomposites may also be used for coating articles by means of powder coating processes or solvent coating processes or as adhesives. Mixtures of different nano-materials can be used to maximize the benefits from each. In the case of conventional reinforcements like fillers, whiskers, and fibers, all standard processing techniques for conventional composites can be used for the polymer nanocomposites, including compression, vacuum bag, autoclave, filament winding, braiding, pultrusion, calendaring, etc.

The nanocomposites of the present invention may be directly molded by injection molding or heat pressure molding, or mixed with other polymers, including other copolymers. Alternatively, it is also possible to obtain molded products by performing an in situ polymerization reaction in a mold.

The nanocomposites according to the invention are also suitable for the production of sheets and panels using conventional processes such as vacuum or hot pressing. The sheets and panels can be laminated to materials such as wood, glass, ceramic, metal or other plastics, and outstanding strengths can be achieved using conventional adhesion promoters, for example, those based on vinyl resins. The sheets and panels can also be laminated with other plastic films by co-extrusion, with the sheets being bonded in the molten state. The surfaces of the sheets and panels can be finished by conventional methods, for example, by lacquering or by the application of protective films.

The nanocomposites of this invention can also be used in continuous fiber composite applications such as are used in aircraft, missiles and ship structures where the continuous fibers can be glass or carbon. They can be used with traditional composite processing technology such as resin transfer molding (RTM), pultrusion, or prepregging.

The nanocomposites of this invention can also be used in the formulation, in part or as a whole, of adhesives for structural and electronic applications and as sealants and encapsulants for electronic devices.

The nanocomposites of this invention are also useful for fabrication of extruded films and film laminates, as for example, films for use in food packaging. Such films can be fabricated using conventional film extrusion techniques. The films are preferably from 10 to 100, more preferably from 20 to 100, and most preferably from 25 to 75, microns thick.

The invention will now be further illustrated by the following non-limiting examples.

### EXAMPLES

### Example A

### Curing of Epoxy Resins with RTIL

1. Materials

The epoxy resin used is a diglycidyl ether of bisphenol A (EPON™ 828, n=0.13, Miller Stephenson) and the RTIL used was ethyl-methyl imidazolium dicyanamide (emimdcn, Solvent Innovation GmBh). The tetra-functional amine used was 4,4-methylenebiscyclohexanamine, (PACM, Air Products and Chemicals). All chemicals were used as received. The chemical structures of the materials used are shown below. Samples are prepared by dispersing a known weight fraction of emimdcn in EPON™ 828 while the control samples are PACM cured EPON™ 828 at stoichiometry. See e.g. Palmese, G. R. and McCollough, R. L., “Effect of epoxy-amine stoichiometry on cured resin material properties,” Journal of Applied Polymer Science, 1992. 46(10): p. 1863-1873. The cure schedule used was as follows: After sufficient mixing, samples were allowed to sit for 15 minutes and then heated at 80° C. for 2 hours followed by heating at 165° C. for 2 hours.

Chemical structures of: (a) EPON™ 828, (b) PACM20 and (c) emimdcn:

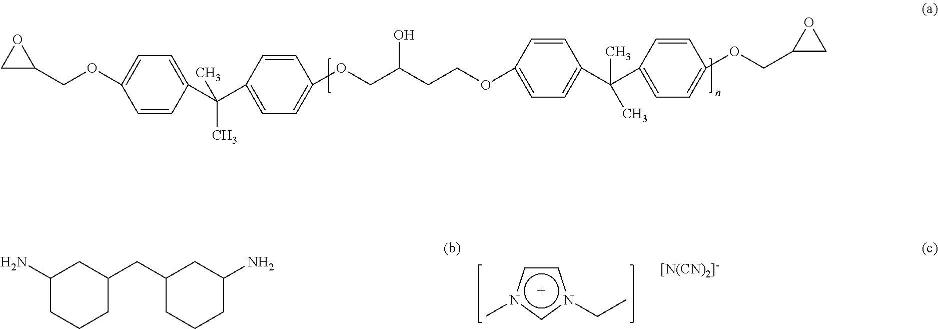

2. Water Uptake

Hydrophilicity of the epoxy thermosets was quantified gravimetrically on small rectangular samples immersed in deionized water with a thickness of approximately 1 mm using the following equation: Wₜₓ−Wₜ₀/Wₜ₀, where W is the sample weight at time t=x min.

3. Dynamic Mechanical Analyses and Differential Scanning Calorimetry

Viscoelastic behavior of the synthesized copolymers was determined on a TA Instruments 2980 DMA in the single-cantilever mode on rectangular samples that were cut down to pre-measured sizes. The glass transition temperature (Tg) was determined as the tan 8 maximum of the second temperature ramp taken at an amplitude of 1 Hz and a deflection of 15 μm. Temperature scans on both runs were kept between 35 and 250° C. at a scan rate of 10° C./min.

Differential scanning calorimetry (DSC) thermograms were recorded with a TA Instruments DSC Q2000 under a dry nitrogen gas flow of 50 mL/min. Heating scans were done on uncured samples at 2° C./min between 30° C. and 200° C. to initiate and complete the reaction followed by a temperature scan at 2° C./min to determine the Tg of the cured product.

4. Thermal Latency

An experiment was conducted comparing pure EPON™ 828 and EPON™ 828 with 2.9 weight percent dissolved emimdcn which has been kept at ambient conditions for more than 60 days. The system reacts only when the temperature is raised to above 80° C. The absence of any observable visible change in the transparency over long periods of time and the apparent thermal latency suggests that this system may be ideal for one-pot epoxy formulations.

5. Network Hydrophilicity

The uptake profiles for epoxy cured with emimdcn and those cured with amine are similar and do not reach equilibrium after a prolonged period of time. It is also observed that the water uptake of emimdcn cured samples is proportional to the concentration of RTIL used for cure. At the highest concentration of RTIL (9.9%), the network increases in weight by about 2% in 30 days as compared to the amine cured epoxy which takes up about 0.8% water over the same period of time.

It is known that emimdcn is infinitely miscible with water. It is likely that the concentration of water solvated into the network structure is dependant on the polarity of pendant groups on the polymer chain which in this case follows the concentration of the hydrophilic emimdcn.

The differences in hydrophilicity within the polymer might also be a result of the contribution to the dissolution of water by unreacted ionic liquid, emimdcn, rather than the polymer network. The hypothesis was tested by drying out water swollen samples at 100° C. and 24 hours. The resulting loss in dry weight is significantly lower than the amount of emimdcn used for initiation suggesting that the initiator is covalently bound onto the network and is not free to leach out.

It has also been reported that the differences in free volume in epoxy thermosets alters the ultimate water uptake. This free volume within a polymer network is a result of nanovoids whose volume can be occupied by water molecules and can be controlled by the type of network structure being formed. This phenomena may play a role considering that there are changes in the cross-link density and glass transition temperature with variations in emimdcn concentration.

6. Evaluation of Network Structure

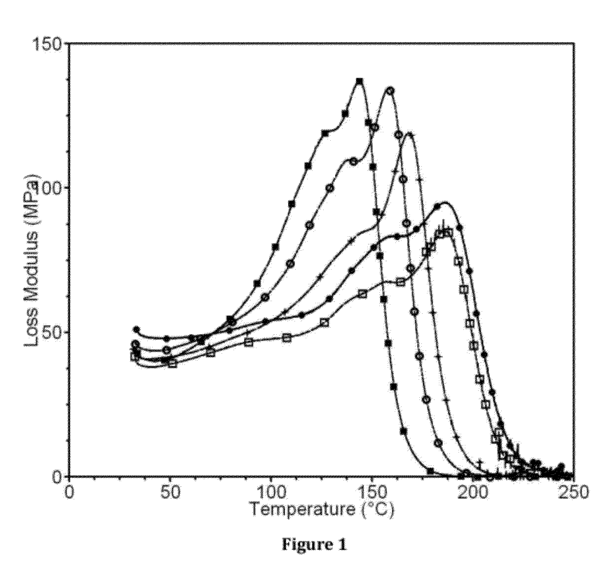

FIG. 1 shows curves of loss modulus versus temperature for samples cured with varying amounts of emimdcn. It is seen that an increasing concentration of emimdcn leads to lower loss modulus maxima and glass transition temperatures, Tg, from 200° C. at 3.2% emimdcn to 140° C. at 9.9% emimdcn. The observation of decreasing Tg is in contrast to epoxies cured with emim BF₃ which exhibits increasing Tg.s with increasing initiator concentrations. In addition to this peak, the presence of a second, smaller loss modulus maximum is indicative of the presence of a secondary network structure being formed.

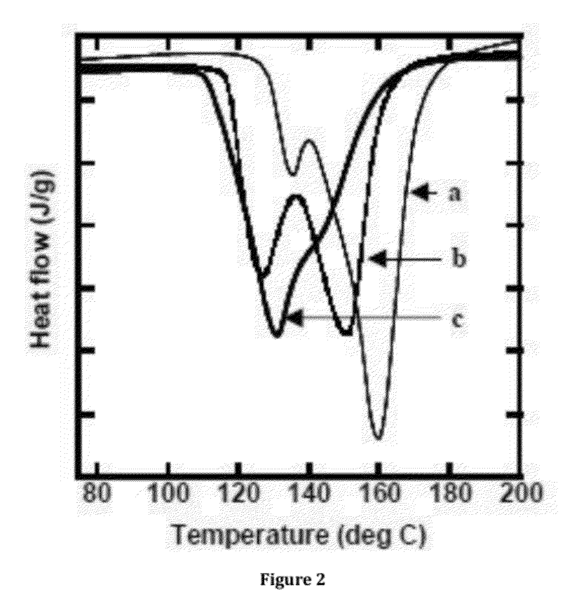

FIG. 2 shows DSC thermograms of EPON™ 828 with different weight fractions of emimdcn cured at 2° C./min in a DSC pan. From the plot, it is observed that there are two exothermic peaks of differing intensities. Although, the total heat flow computed as the integral peak area is a constant (approximately 550 J/g), the ratio between the areas of the two peaks varies with the emimdcn concentration.

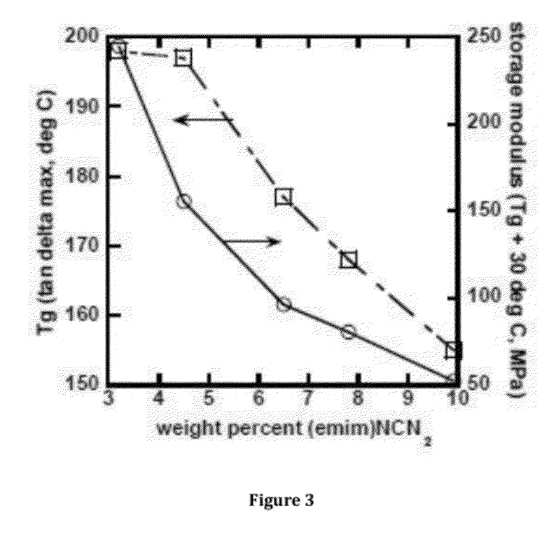

Differences in tan δpeak width, peak maximum, temperature and rubbery modulus are dependent on the cross-link density of the network structure. FIG. 3 is a plot of the Tg and the rubbery modulus (storage modulus at Tg+30° C.) as a function of the weight percent of emimdcn used. The data show that networks with the highest glass transition temperatures correspond to the highest rubbery modulus (and cross-link densities) with these values decreasing proportionally as the concentration of IL is increased.

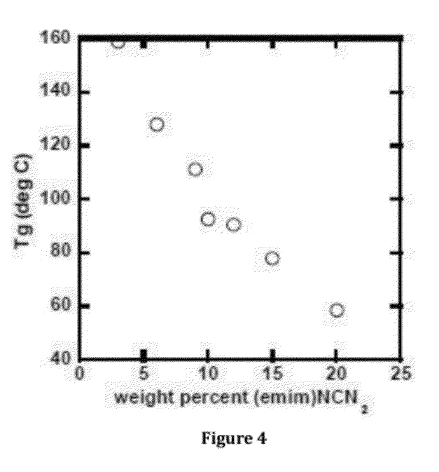

FIG. 4 shows a plot of Tg as a function of the weight percent emimdcn used as obtained from the DSC after an initial temperature scan was carried out at 2° C./min to complete the reaction. The trend shown follows that obtained using the DMA where the Tg decreases with increasing emimdcn content.

TABLE 2
Char yield at 600° C. and decomposition temperature,
Td, at 80% weight loss at different emimdcn initiator
concentrations compared to cationically cured EPON ™ 825
and amine cured EPON ™ 828

| Sample | Char Yield (%) | Td (° C.) |
|---|---|---|
| EPON ™ 828 (1 wt %) | 2.5 | 413 |
| EPON ™ 828 (3 wt %) | 3.3 | 413 |
| EPON ™ 828 (9 wt %) | 6.1 | 412 |
| EPON ™ 825 (catalyst) | 0.0 | 414 |
| EPON ™ 828 (amine) | 8.0 | 367 |
| emimdcn | 20.6 | 294 |

Example 1 shows the use of emimdcn as a latent curing agent for EPON™ 828. The synthesized materials show hydrophilicity proportional to the emimdcn content. Thermomechanical analysis results in glass transition temperatures of about 200° C. and shows a strong dependence of the Tg on the emimdcn content. The dependence of Tg on emimdcn content is also found using differential scanning calorimetry. The results indicate that there may be a complicated cure mechanism involved.

### Example B

### Step-growth Polymerizations in Non-Reactive Ionic Liquids

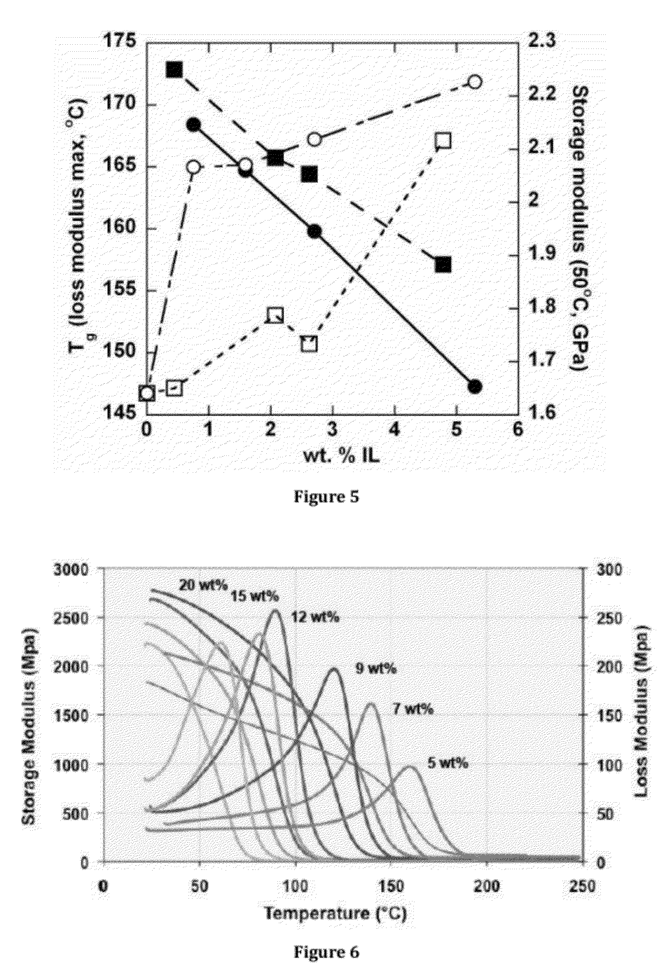

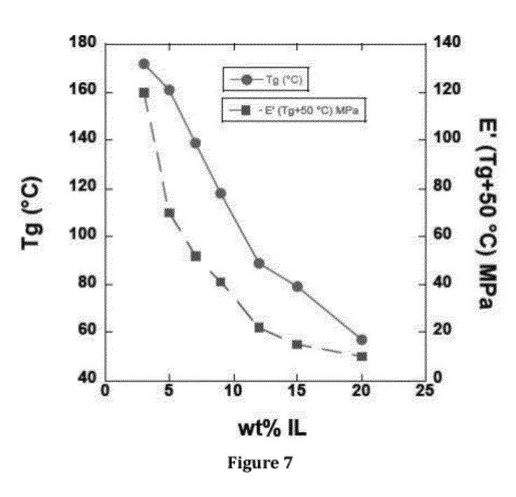

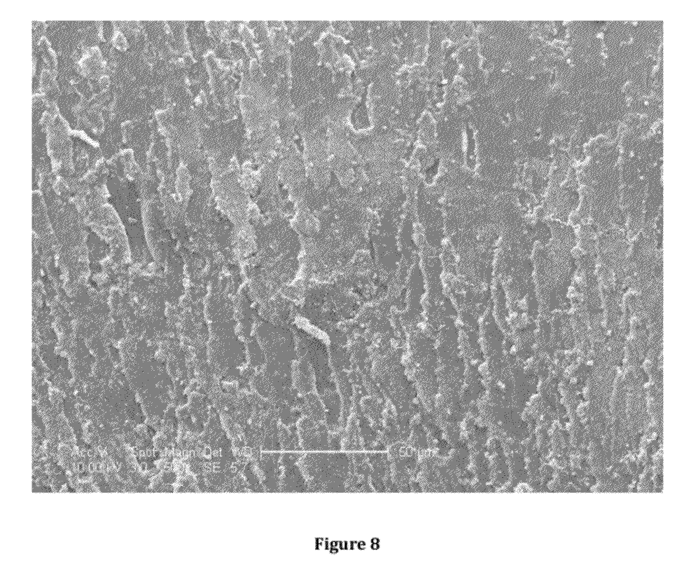

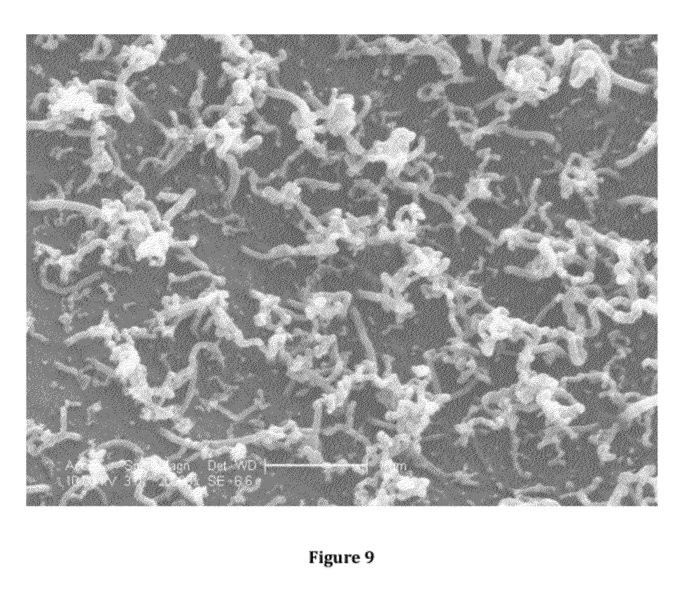

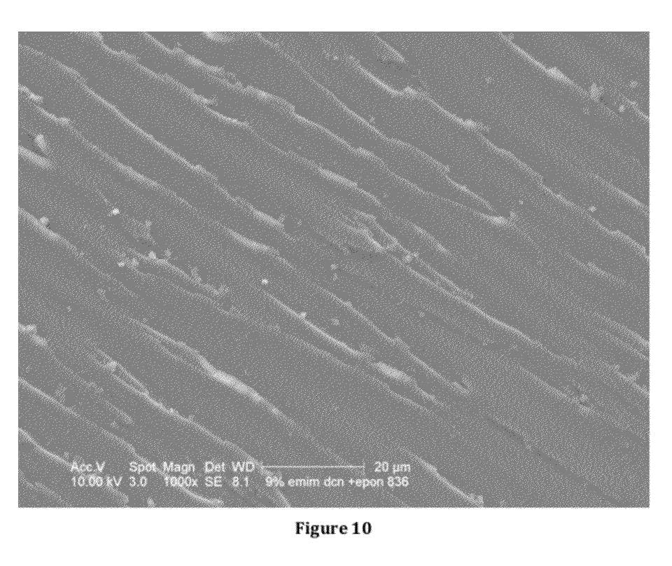

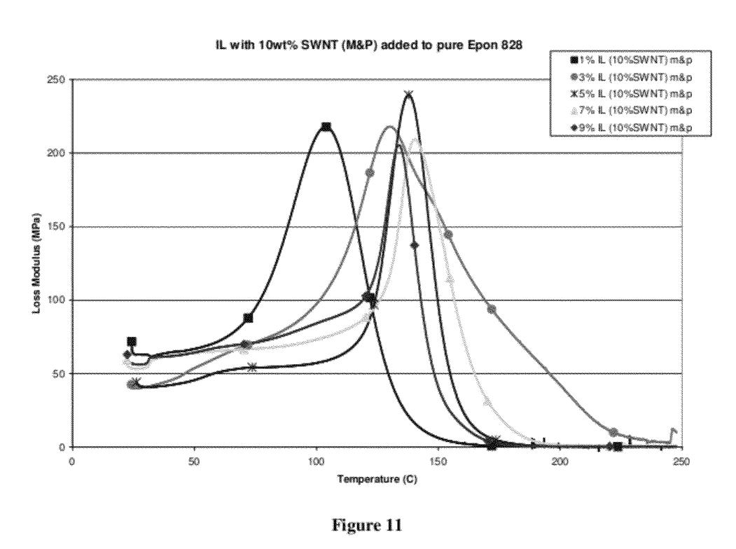

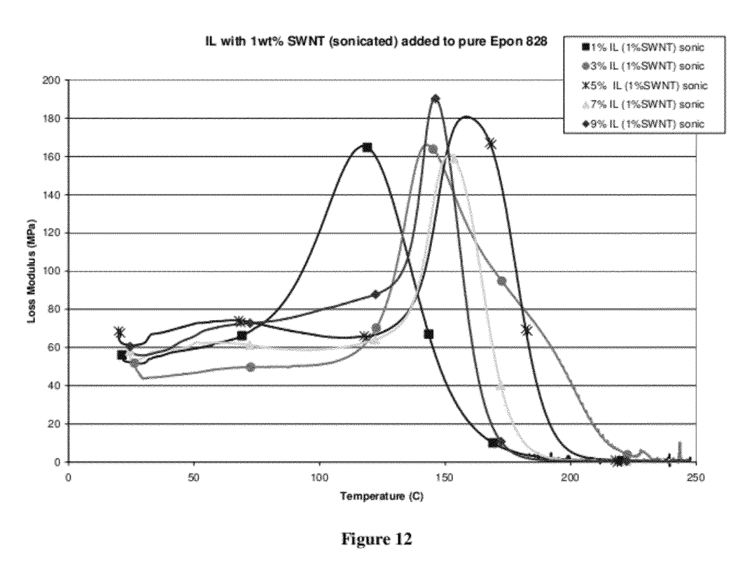

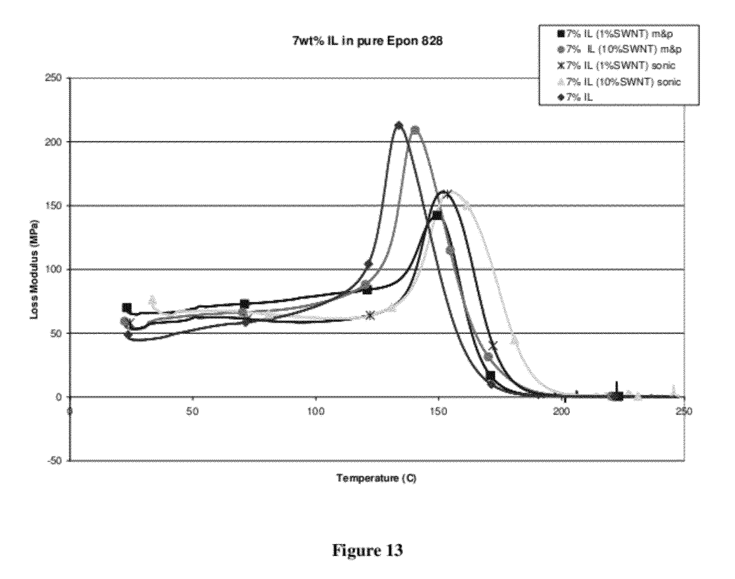

Ionic liquids that dissolve in, but do not react with, epoxide groups may be used to disperse ionic groups within the network structure to modify properties. An example of this is EPON™ 828-PACM cured in the presence of non-reactive but soluble ionic liquids. Two examples of such ionic liquids are emim ethylsulfate and emim tosylate. FIG. 5 is a plot of the Tg and storage modulus of fully cured epoxy-amine thermosets in the presence of emim ethylsulfate and emim tosylate compared to epoxyamine thermosets cured without any ionic liquid. For thermosets cured with either of these ionic liquids, there is a distinct increase in the storage modulus at room temperature (glassy modulus) suggesting possible internal anti-plasticization effects. The loss modulus peaks indicate a significant depression in the Tg for both emim ethylsulfate and emim tosylate. Similar behavior has been observed for PMMA in the presence of ionic liquids and is considered to be due to increased chain mobility in the vicinity of low molecular weight solvents which lower the overall Tg.

### Examples 1-24

### Preparation of Nanocomposites

### Experimental Procedures

1. Procedure for Creating Materials Including Single-Walled Nanotubes (SWNT's) Ionic Liquid (IL) and Epoxy (Epon™ 828).

First, the SWNT is mixed into the IL in the desired amount. Mixing may be accomplished by any suitable mixing technique since the mixing method shows no visual effect on material. Exemplary mixing techniques include mixing with mortar and pestle for 30-45 minutes and sonication for 3 hours.

Mixing/grinding SWNT into the IL at a temperature of about 22-25° C. resulted in a dark colored liquid in amounts up to about 10 wt %, and for amounts above 10 wt % of SWNT in IL, typically a thick black paste was obtained. Loadings of up to 21 wt % SWNT in IL were carried out.

Then, SWNT in IL was added to Epon™ 828 in amounts of 1, 3, 5, 7, and 9 wt %. A viscous dark (black) liquid resulted; the higher the concentration of SWNT the more opaque the material appeared. The materials were mixed for 5 minutes at 2000 rpm at a temperature of about 22-25° C. All samples were post-cured at 120° C. for 2 hours except samples containing 1 wt % SWNT/IL in Epon™ 828 took up to 24 hours to cure. Once cured, all samples become completely opaque black, solid materials.
2. Procedure for Creating SWNT/IL/Epon™ 828 Material with Adduct

In this procedure, the SWNT was mixed into the IL at amounts of 1-10 wt % SWNT using the mixing techniques described above in the first experimental procedure. Then, a mixture of SWNT/IL and Epon™ 828 was prepared having 1:1 molar ratio of IL Epon™ 828. This correlates to a 1:6.97 weight ratio of IL:Epon™ 828 when the IL is 1-ethyl-3-methyl-imadazolium dicyanimide. This produced a black very viscous solid. Lower wt % contents of SWNT are more translucent than higher wt % content SWNT mixtures. The 1:1 molar mixture creates linear chains of IL:Epon™ 828 in the product. Mixing was carried out for 5 minutes at 2000 rpm at temperature of about 22-25° C. Once mixed, the composition was located in an open vial and placed in a vacuum oven at 100° C. overnight (˜12 hours) to draw out excess water.

Subsequently, the mixture of SWNT/IL/Epon™ 828 having 1:1 molar ratio of IL/Epon™ 828 was added to additional Epon™ 828. For each of 1 wt % and 10 wt % SWNT in IL, the mixture of SWNT/IL/Epon™ 828 was added to pure Epon™ 828 in amounts of 1, 3, 5, 7, 9, 30, and 50 wt %. By adding the mixture of SWNT/IL/Epon™ 828 to more Epon™ 828, linear chains are dispersed in the epoxy and the resulting mixture became more translucent, but still exhibited a black/grey color. Mixing was carried out for 5 minutes at 2000 rpm at temperature of about 22-25° C.

All samples were then post-cured at 120° C. for 2 hours. Any samples containing 1 wt % SWNT/IL took up to 24 hours to cure. Once cured, all samples become completely opaque black solid materials.

Twenty nanocomposites of Examples 1-20 were prepared using Experimental procedure 1 using the amounts of SWNT, IL and Epon™ 828 given in Table 1. The mixing process used to mix the materials is given as “M&P” for the mortar & pestle method, or “sonic” for the sonication method. The glass transition temperature, storage modulus and rubbery modulus were measured for each material and the results are given in Table 1.

Four additional nanocomposites of Examples 21-24 were prepared using Experimental procedure 2 wherein an adduct of SWNT in IL and Epon™ 828 was first prepared using a 1:1 molar ratio of IL/Epon™ 828. The amounts of the materials used are given in Table 2. This adduct was then added to additional Epon™ 828 and post-cured to form the nanocomposites of Examples 21-24. The results are shown in Table 2. Again, it is demonstrated that the nanomaterials can be incorporated into the products while maintaining acceptable glass transition temperatures, storage modulus and rubbery modulus of the materials.

TABLE 1
Examples of Materials Made by Experimental Procedure 1

| | | Final | Final | | Storage | Rubbery |
|---|---|---|---|---|---|---|
| | | amount | amount | | Modulus | Modulus |
| Ex | | of SWNT | of IL | Tg | at RT | Tg + 30° C. |
| No | Sample | (wt %) | (wt %) | (° C.) | (GPa) | (MPa) |
| 1 | 1 wt % of (1 wt % SWNT in IL) | .01 | 0.99 | 121 | 2.52 | 150 |
| | added to Epon ™ 828 (M&P) | | | | | |
| 2 | 3 wt % of (1 wt % SWNT in IL) | .03 | 2.97 | 189 | 2.36 | 220 |
| | added to Epon ™ 828 (M&P) | | | | | |
| 3 | 5 wt % of (1 wt % SWNT in IL) | .05 | 4.95 | 166 | 2.15 | 200 |
| | added to Epon ™ 828 (M&P) | | | | | |
| 4 | 7 wt % of (1 wt % SWNT in IL) | .07 | 6.93 | 149 | 2.12 | 180 |
| | added to Epon ™ 828 (M&P) | | | | | |
| 5 | 9 wt % of (1 wt % SWNT in IL) | .09 | 8.91 | 137 | 2.14 | 167 |
| | added to Epon ™ 828 (M&P) | | | | | |
| 6 | 1 wt % of (10 wt % SWNT in IL) | 0.1 | 0.9 | 104 | 2.56 | 134 |
| | added to Epon ™ 828 (M&P) | | | | | |
| 7 | 3 wt % of (10 wt % SWNT in IL) | 0.3 | 2.7 | 130 | 2.87 | 160 |
| | added to Epon ™ 828 (M&P) | | | | | |
| 8 | 5 wt % of (10 wt % SWNT in IL) | 0.5 | 4.5 | 138 | 2.71 | 168 |
| | added to Epon ™ 828 (M&P) | | | | | |
| 9 | 7 wt % of (10 wt % SWNT in IL) | 0.7 | 6.3 | 140 | 2.43 | 170 |
| | added to Epon ™ 828 (M&P) | | | | | |
| 10 | 9 wt % of (10 wt % SWNT in IL) | 0.9 | 0.81 | 134 | 2.45 | 164 |
| | added to Epon ™ 828 (M&P) | | | | | |
| 11 | 1 wt % of (1 wt % SWNT in IL) | .01 | 0.99 | 117 | 2.45 | 147 |
| | added to Epon ™ 828 (Sonic) | | | | | |
| 12 | 3 wt % of (1 wt % SWNT in IL) | .03 | 2.79 | 143 | 2.19 | 173 |
| | added to Epon ™ 828 (Sonic) | | | | | |
| 13 | 5 wt % of (1 wt % SWNT in IL) | .05 | 4.95 | 159 | 2.93 | 189 |
| | added to Epon ™ 828 (Sonic) | | | | | |
| 14 | 7 wt % of (1 wt % SWNT in IL) | .07 | 6.93 | 152 | 2.27 | 182 |
| | added to Epon ™ 828 (Sonic) | | | | | |
| 15 | 9 wt % of (1 wt % SWNT in IL) | .09 | 8.91 | 146 | 2.80 | 176 |
| | added to Epon ™ 828 (Sonic) | | | | | |
| 16 | 1 wt % of (10 wt % SWNT in IL) | 0.1 | 0.9 | 106 | .2.61 | 136 |
| | added to Epon ™ 828 (Sonic) | | | | | |
| 17 | 3 wt % of (10 wt % SWNT in IL) | 0.3 | 2.7 | 157 | 2.50 | 187 |
| | added to Epon ™ 828 (Sonic) | | | | | |
| 18 | 5 wt % of (10 wt % SWNT in IL) | 0.5 | 4.5 | 167 | 7.63 | 197 |
| | added to Epon ™ 828 (Sonic) | | | | | |
| 19 | 7 wt % of (10 wt % SWNT in IL) | 0.7 | 6.3 | 155 | 2.33 | 185 |
| | added to Epon ™ 828 (Sonic) | | | | | |
| 20 | 9 wt % of (10 wt % SWNT in IL) | 0.9 | 0.81 | 152 | 2.54 | 182 |
| | added to Epon ™ 828 (Sonic) | | | | | |

TABLE 2
Examples of Materials Made by Experimental Procedure 2

| | | Final | Final | | Storage | Rubbery |
|---|---|---|---|---|---|---|
| | | amount | amount | | Modulus | Modulus, |
| Ex | | of SWNT | of IL | Tg | at RT | Tg + 30° C. |
| No | Sample | (wt %) | (wt %) | (° C.) | (GPa) | (MPa) |
| 21 | 30% of adduct containing 1 wt % | .0375 | 3.7125 | 156 | 1.93 | 186 |
| | SWNT in IL added to Epon ™ 828 | | | | | |
| 22 | 30% of adduct containing 10 wt % | .375 | 3.375 | 152 | 1.60 | 182 |
| | SWNT in IL added to Epon ™ 828 | | | | | |
| 23 | 50% of adduct containing l wt % | .0625 | 6.1875 | 115 | 2.60 | 145 |
| | SWNT in IL added to Epon ™ 828 | | | | | |
| 24 | 50% of adduct containing 10 wt % | .625 | 5.625 | 114 | 2.37 | 145 |
| | SWNT in IL added to Epon ™ 828 | | | | | |

### Examples 25-26

### Nanocomposites Using Cellulose Materials

### 1. Materials

Five different kinds of celluloses, namely, a-cellulose, cellulose acetate 1 (CA1) (39.8 wt % acetal, Mₙ=30,000), cellulose acetate 2 (CA2) (˜40 wt % acetal, Mᵣ=29,000), 2-hydroxyethyl cellulose acetate(HECA) (Mᵥ=90,000), and quaternized hydroxyethyl cellulose ethoxylate (QHECE), were purchased from Sigma-Aldrich and used without further treatment.

Ionic liquids (IL) tested in this study include three species, which are 1-ethyl-3-methylimidazolium dicyanamide (emimdcn), 1-butyl-3-methylimidazolium dicyanamide (bmimdcn), and 1-butyl-1-methyl-pyrrolidinium dicyanamide (bmpdcn).

### 2. Results

A. Solubility of Three Ionic Liquids

This test was carried out to dissolve a certain amount of CA1 at 90° C. in three ionic liquids. The result showed that the solubility of cellulose in these three ionic liquids is in the order: bmpdcn>emimdcn>bmimdcn. However, since emimdcn has been proven to be a good latent curing agent for epoxy resin, it was chosen for the further examples.

B. Dissolution of Cellulose in Emimdcn

For this test, the cellulose was dried in an oven at 90˜100° C. for 3 hours prior to use, the ionic liquid was dried with molecular sieves and heated at 90˜100° C. for at least 1 hour prior to use. The dissolution results are summarized in Table 3. The results show that functionalized cellulose can be dissolved in emimdcn and that HECA and QHECE show better dissolution in emimdcn compared to CA.

There was some gel formation associated with QHECE and HECE during the dissolution which may due to the physical crosslinking. Therefore, in the synthesis of composite, CA was used as reinforcement material.

TABLE 3
Dissolution of various celluloses in emimdcn at varying conditions

| Cellulose | Amount in | Temperature | | |
|---|---|---|---|---|
| species | 1 g IL | (° C.) | Time (Hrs) | Appearance |
| α-cellulose | 0.1 | 90 | 4 | Not dissolved, |
| | | | | fine particles |
| CA1 | 0.1~0.37 | 90 | Overnight | Yellowish |
| | | | without | solution |
| | | | stirring | |
| CA2 | 0.2~0.5 | 90 | 1~2 with | Yellowish |
| | | | stirring | solution to |
| | | | | high viscosity |
| | | | | paste |
| HECA | 0.3~0.5 | 90 | <1 with | Transparent, |
| | | | stirring | brown color, |
| | | | | high viscosity |
| QHECE | 0.3~0.4 | 90 | <1 with | Transparent |
| | | | stirring | gel, brown |
| | | | | color |

C. Synthesis of CA/Emimdcn/Epon™ 828 Composite

The representative formulations are listed in Table 4 with weight percent of each component in a designed range.

TABLE 4
Representative formulations for the three component composite

| | | Weight percentage of |
|---|---|---|
| Components | Weight percentage (%) | IL with respect to epoxy |
| Epon ™ 828 | 54~67 | — |
| emimdcn | 27~38 | 30~40 |
| CA1 | 4~10 | — |

D. Synthesis Procedure.

The three component composite was made based on the following procedure. An amount of CA1, e.g. 0.5 g, was put in a 20 ml vial. A corresponding amount of emimdcn was added into the vial. After mixing, the vial was left in an oven at 90° C. overnight. A clear yellowish solution was obtained. Then, a corresponding amount of epoxy was added into the vial, after mixing, the vial was put in the oven at 90° C. for several hours until a translucent solution was formed. At this stage, the color of the translucent solution is brown. The formed resin was cured in a mold at 120° C. for 3 hours and then heating was continued at 150° C. for another 2 hours. DMA tests were carried out on the cured samples.

E. DMA Results

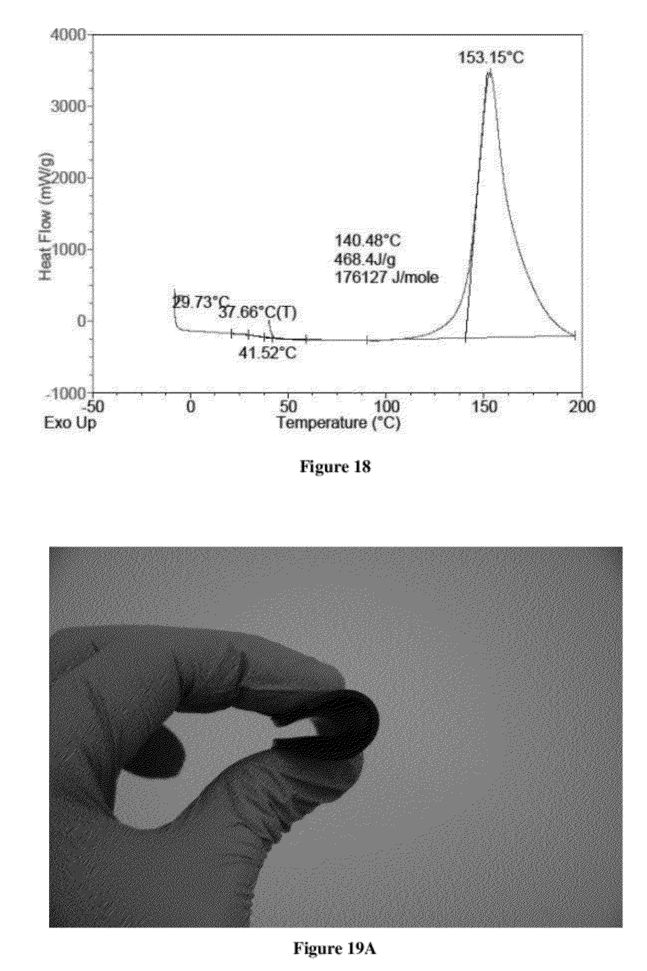

Two representative DMA plots are shown in FIGS. 17-18 corresponding to two different formulations. In relation to FIG. 17 (Example 25), the composition was Epon™ 828 6.3 g, emimdcn 2.7 g, and CA1 1 g. In relation to FIG. 18 (Example 26), the composition was Epon™ 828 6.44 g, emimdcn 2.76 g, and CA1 0.8 g. It can be seen from the plots that the T_{g}s of the samples ranged from 30° C. to 50° C.

### Example 27

### Nanocomposite Made with Nanoclav

### Materials

Nanoclay: Cloisite™ 93A 90meq M2HT/100 g clay (M2HT: methyl, dehydrogenated tallow, quaternary ammonium)
Ionic Liquid: 1-ethyl-3-methylimidazolium dicyanamide

### Epoxy Resin: Epon™ 828

### Clay+Ionic Liquid+Epoxy Composites

### Sample Preparation

0.5162 grams of Cloistie 93A was mixed with 4.6458 grams of 1-ethyl-3-methylimidazolium dicyanamide (IL) and placed in an oven at 110° C. for 10 minutes uncover. The sample was mixed again at 2000 rpm for 1 minute and replaced in the oven at 110° C. for 10-15 minutes uncovered. The sample was then mixed again at 2000 rpm for 1 minute, cooled to room temperature, remixed and replaced in the oven uncovered at 110° C. for 40 minutes. The material was then covered and cooled to room temperature.

3.1915 grams of Epon™ 828 were then added and the material was covered and maintained at 80° C. for 15 minutes, mixed for 1 minute at 2000 rpm, uncovered and maintained an additional 15 minutes at 80° C. The sample was then remixed for 1 minute at 2000 rpm and room temperature and an additional 3.0264 grams of Epon™ 828 was added. The mixture was mixed at 2000 rpm for 1 minute, poured into an open mold and held at 80° C. for 10 minutes. The temperature was then slowly raised to 115° C. and maintained for 1 hour and 45 minutes. The sample was cooled to room temperature and removed from the mold.

### Results

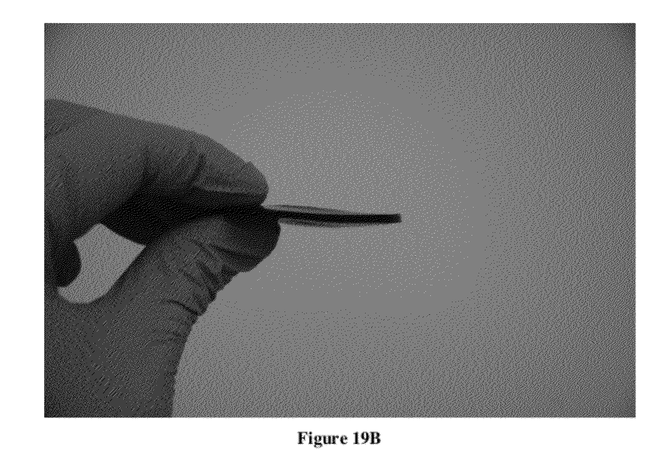

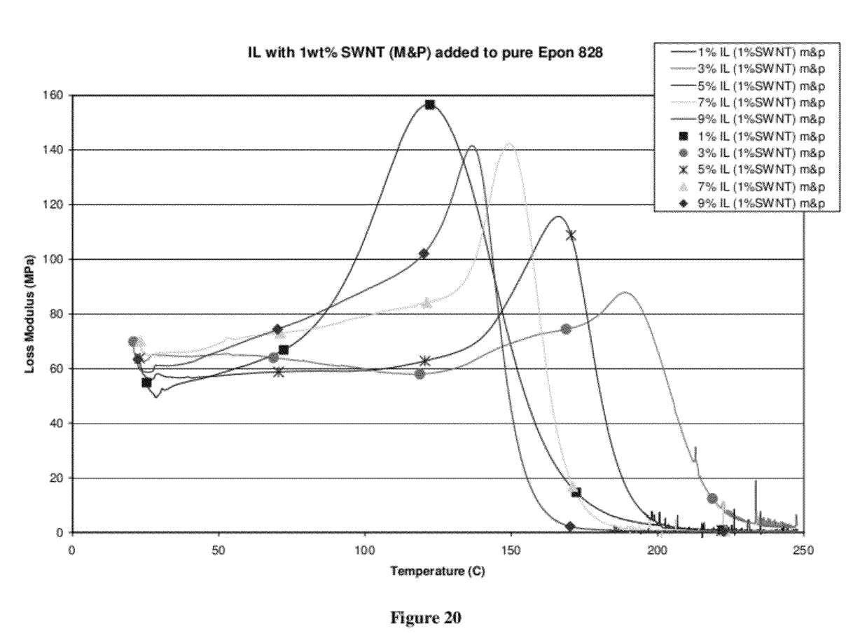

The 4.5 wt % 93A, 41 wt % IL and 54.5 wt % Epon™ 828 sample yielded rubbery plaques of nominal dimensions of (diameter=49 mm, thickness=4.52 mm in the center and 2.4 mm at the edge) When bent and released, the samples returned to their original shape (FIGS. 19A-19B). No signs of plastic deformation were observed.

### Example 28

### Nanocomposite Made With Silica

### Materials

1-ethyl-3-methyl imidazolium dicyanamide (EMIM-DCA) was purchased from EMD Sciences (Catalog #4.90163), and used as received. (3-glycidoxypropyl) trimethoxysilane (GPTMSi) was purchased from Sigma Aldrich (Product number 440167) and used as received. Silicon dioxide nanopowder, 5-15 nm particle size (Product #637246) was purchased from Sigma-Aldrich, and dried in air at 120° C. for 24 hours.

### Silica Dispersion

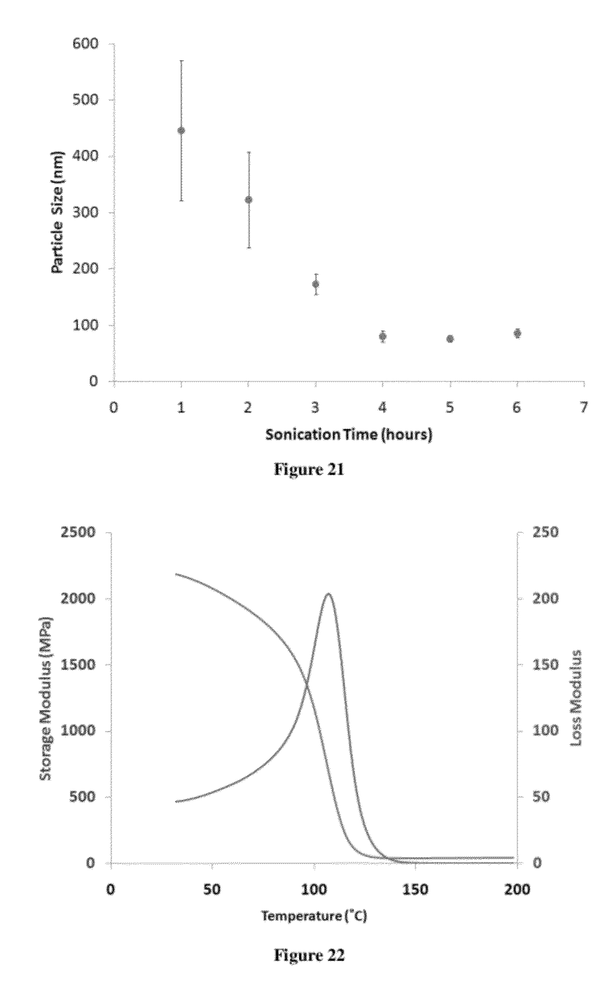

For the dispersion experiment, 2.0 mg Silica nanopowder were added into a solution of 3.0 g EMIM-DCA and 4.0 mg GPTMSi. This solution was mixed briefly with a stirring rod before sonication in glass vial in a Cole-Parmer 8893 bath ultrasonicator. After mixing, but before sonication, visible silica clumping was observed. Beginning after the first hour of sonication, samples were taken from the main vial, diluted into EMIM-DCA until the particle count was within the optimal range, and analyzed using a Malvern Zetasizer DS-90. 13 measurements were taken at each time step, and averaged. The results are shown in FIG. 21. The trend in the particle size shows both a decrease in average particle size, suggesting dispersion, as well as a narrowing of the variation between measurements, suggesting a return to monodisperse particles, rather than amorphous aggregates.

### Silica Nanocomposite Properties

The materials used as the same as for the previous silica dispersion experiment with the addition of EPON™ 828 purchased from Miller-Stephenson and used as received.

0.075 g of GPTMSi was added to 9.7 g EMIM-DCA, mixed by hand and in a Cole-Parmer 8870 bath sonicator for 30 minutes. This solution was added dropwise into 1.5 g of silica nanoparticles in a mortar over a period of one hour and ground in with a pestle. After mixing, the solution was sonicated in a Cole-Parmer 8870 bath sonicator for 1 hour. 38.8 g of EPON 828 was added to the solution, mixed for 30 minutes in a Thinkee rotational mixer, and sonicated in a Cole-Parmer 8870 bath sonicator for an additional 3 hours. This solution was cured at 105° C. overnight, with a 2 hour post cure at 120° C.

The resulting solid material was sanded to a standard size and shape, and tested in a TA Instruments Q800 DMA using a single-cantilever clamp configuration at 1 hZ, with a ramp rate of 2° C./min. The material yielded a storage modulus of 2185 MPa at 32° C., with a glass transition temperature of 105° C. (by loss modulus peak) as shown in FIG. 22.

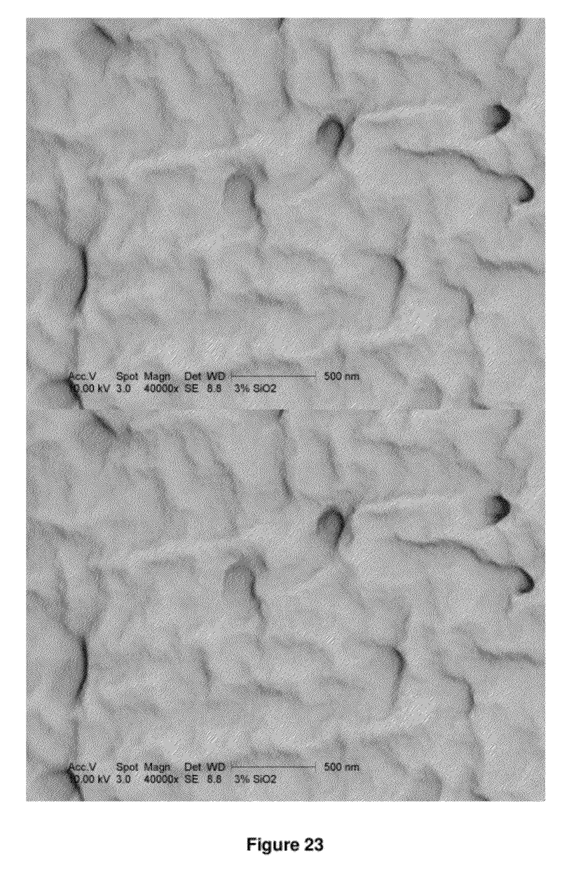

The samples were fractured, and the fracture surfaces were sputter coated with Pt/Pd for 30 seconds at 40 mA using a Cressington 208HR sputter coater, and SEM images were taken using an FEI XL30 ESEM. The images (FIG. 23) showed well-dispersed silica particles with unique fracture interaction with the bulk epoxy.

### Example 29

### Nanocomposite Made with Graphene

### Graphene Dispersion

0.1 g XG Sciences M5 xGNP graphite nanoplatelets (7 nm thickness, 5 μm diameter platelets) used as received were added to 1.5 g EMIM-DCA. This solution was stirred manually, and sonicated for a range of times between 0 and 60 minutes using a Hielscher 200S probe sonicator. The resultant slurry was then mixed with 8.5 g EPON™ 828 (used as received), manually stirred, and sonicated for an additional hour in a Cole-Parmer 8893 bath ultrasonicator.

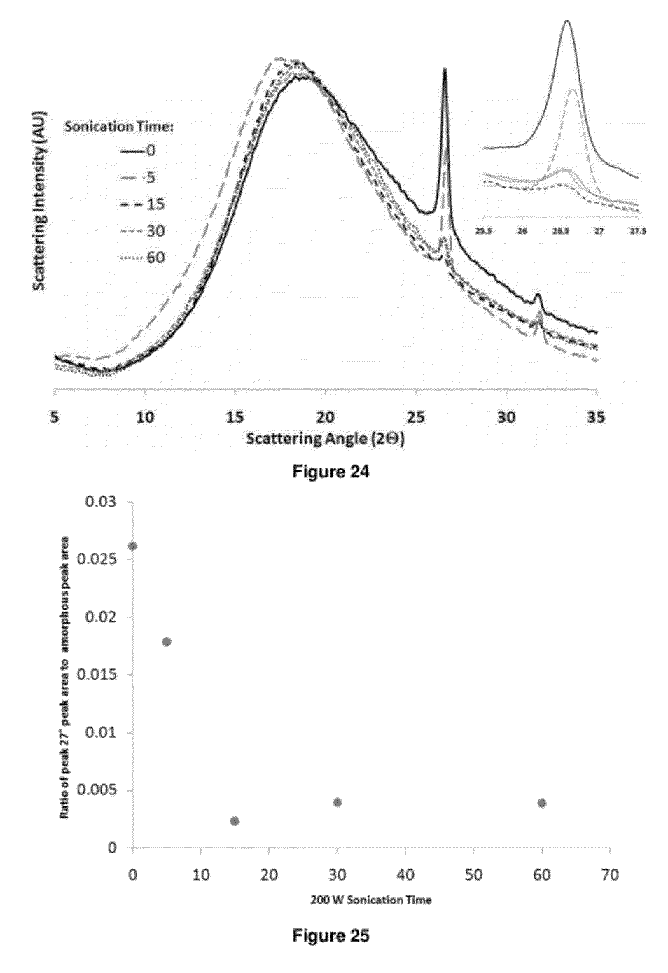

After mixing, the solution was degassed for 2 hours at 60° C. under active vacuum, cast for 12 hours at 80° C., and post-cured for 2 hours at 120° C. The solid samples were sanded and polished to remove surface irregularities. The x-ray diffraction patterns, shown in FIG. 24, were analyzed using a Siemens D500 X-Ray Diffractometer, with a 1500 W, 1.54 Å Cu x-ray source, a 4 second dwell time, and 0.04° data spacing. The primary graphite peak at a scattering angle of 26.6° decreased markedly upon ultrasonic processing. A comparison of the area of that peak with the large amorphous peak between 7° and 35° (FIG. 25) shows a strong, consistent, decrease. This suggests the disordering and dispersion of the previously well-ordered graphite layers.

### Graphene Nanocomposite Properties

0.1 g XG Sciences M5 xGNP graphite nanoplatelets (7 nm thickness, 5 μm diameter platelets) used as received were added to 1.5 g EMIM-DCA. This solution was stirred manually, and sonicated for a range of times between 0 and 60 minutes using a Hielscher 200S probe sonicator. The resultant slurry was then mixed with 8.5 g EPON™ 828 (used as received), manually stirred, and sonicated for an additional hour in a Cole-Parmer 8893 bath ultrasonicator.

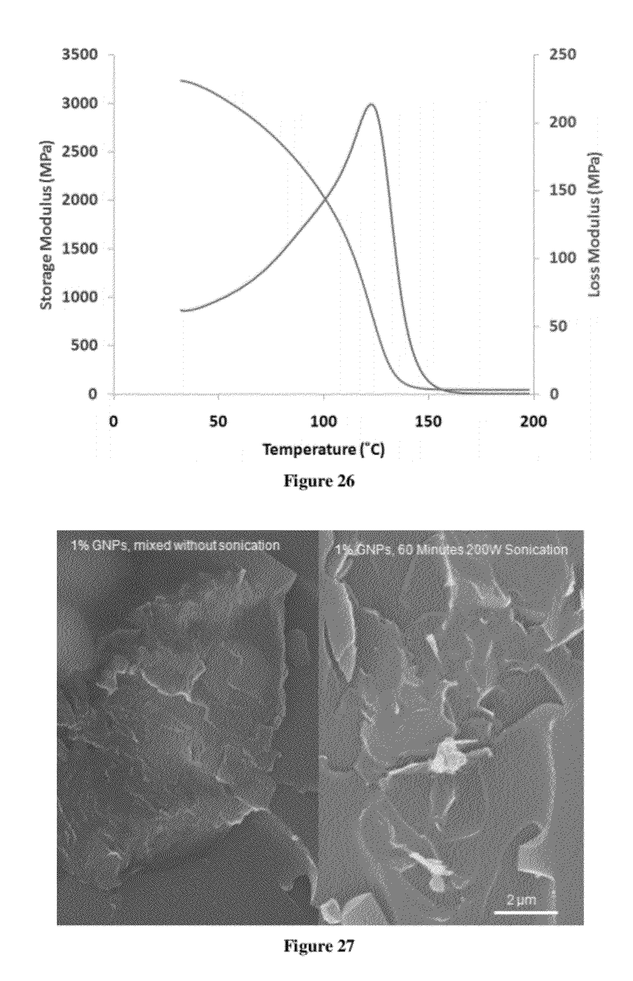

After mixing, the solution was degassed for 2 hours at 60° C. under active vacuum, cast for 12 hours at 80° C., and post-cured for 2 hours at 120° C. The resulting solid material was sanded to a standard size and shape, and tested in a TA Instruments Q800 DMA using a dual-cantilever clamp configuration at 1 hZ, with a ramp rate of 2° C./min. The material yielded a storage modulus of 3236 MPa at 32° C., with a glass transition temperature of 121° C. (by loss modulus peak), as shown in FIG. 26.

The samples were fractured, and the fracture surfaces was sputter coated with Pt/Pd for 30 seconds at 40 mA using a Cressington 208HR sputter coater, and SEM images were taken using an FEI XL30 ESEM. The images (FIG. 27) showed a marked difference between the samples that had undergone sonication, and the ones that were merely mixed. The mixed samples showed small clusters of stacked graphene sheets, while the most heavily sonicated samples showed a richer variety of surfaces and complete exfoliation.

### Example 30

### Nanocomposite Made with Silica and Graphene

0.10 g xGNP H5 Graphite Nanoplatelets (XG Sciences, used as received) were added to 0.90 g EMIM-DCA, stirred, and sonicated for 1 hour in a Cole-Parmer 8893 bath ultrasonicator. After sonication, 9.10 g of Nanopox F-400 silica-infused epoxy (Nanoresins AG, used as received) was added, followed by an additional stirring step and an additional 1 hour of sonication in a Cole-Parmer 8893 bath ultrasonicator. The resulting material was degassed at 60° C. under vacuum for 2 hours, and subsequently cast at 80° C. for 12 hours, and then post-cured for 2 hours at 120° C.

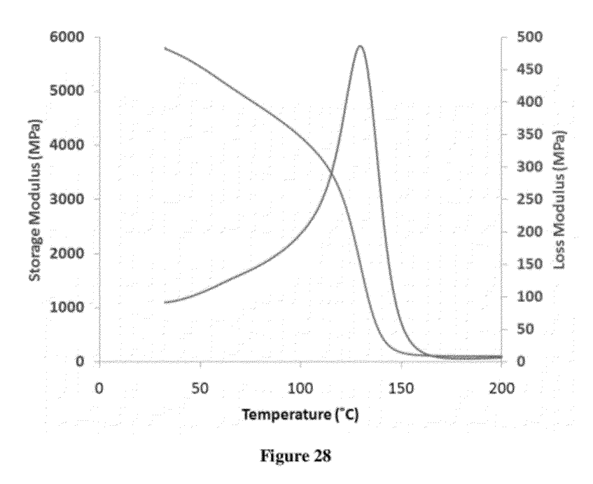

The resulting material was tested in a TA Instruments Q800 DMA using a dual-cantilever clamp configuration at 1 hZ, with a ramp rate of 2° C./min. The material yielded a storage modulus of 5806 MPa at 32° C., with a glass transition temperature of 128° C. (by loss modulus peak) as shown in FIG. 28.

The samples were fractured, and the fracture surfaces was sputter coated with Pt/Pd for 30 seconds at 40 mA using a Cressington 208HR sputter coater, and SEM images were taken using an FEI XL30 ESEM. The resulting images show both small silica particles and large sheets corresponding to graphene layers.

### Examples 31-32

### Ionic Liquids as Dispersive Agents for Cloisites™ in Epoxy-Based Thermosets

Cloisites™ were mixed in 1-ethyl-3-methylimidazolium dicyanamide (emimdcn) and 1-ethyl-3-methylimidazolium ethylsulfate (emim EtSO₄). Emimdcn has been shown previously to act as a curing agent for epoxy systems, while emim EtSO₄ does not have such ability. The emimdcn solutions were mixed with a diepoxy and the mixtures were cured. Emim EtSO₄ solutions were mixed with a diepoxy and diamine curing agents. For comparison, Cloisites™ were mixed with the diepoxy and diamine curing agents. It was found that the ionic liquids act as effective dispersive agents for Cloisites™ and potentially intercalate Cloisite™ layers.

### Materials

The ionic liquids used were 1-ethyl-3-methylimidazolium dicyanamide (emimdcn) and 1-ethyl-3-methylimidazolium ethylsulfate (emim EtSO₄). EPON™ 828, a diglycidyl ether of bisphenol A (DGEBA) with n=0.13 from Miller-Stephenson, was dried under vacuum. 4,4′-methylene biscyclohexanamine (PACM) from Air Products was used as received. Cloisites™ Na⁺, 10A, 15A, 20A, 25A, 30B, and 93A from Southern Clay Products were dried before use.

### Sample Preparation

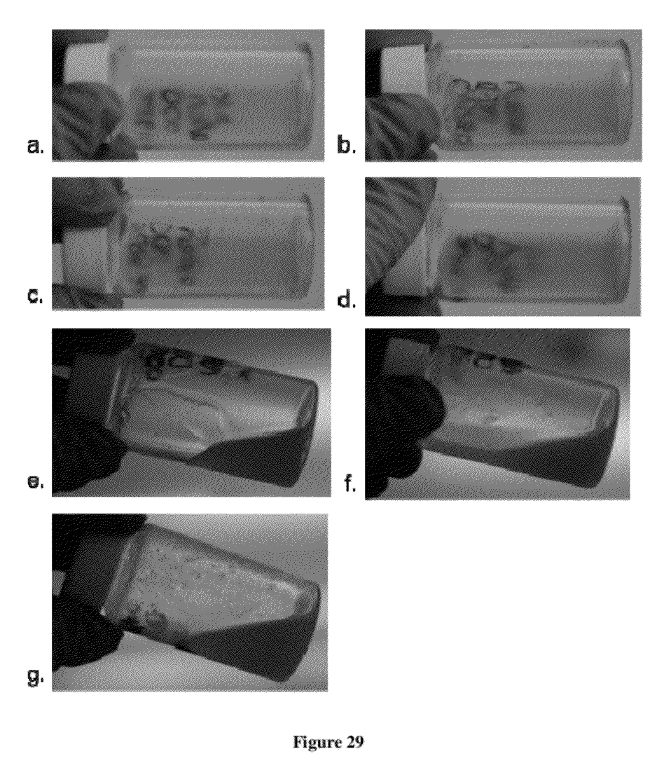

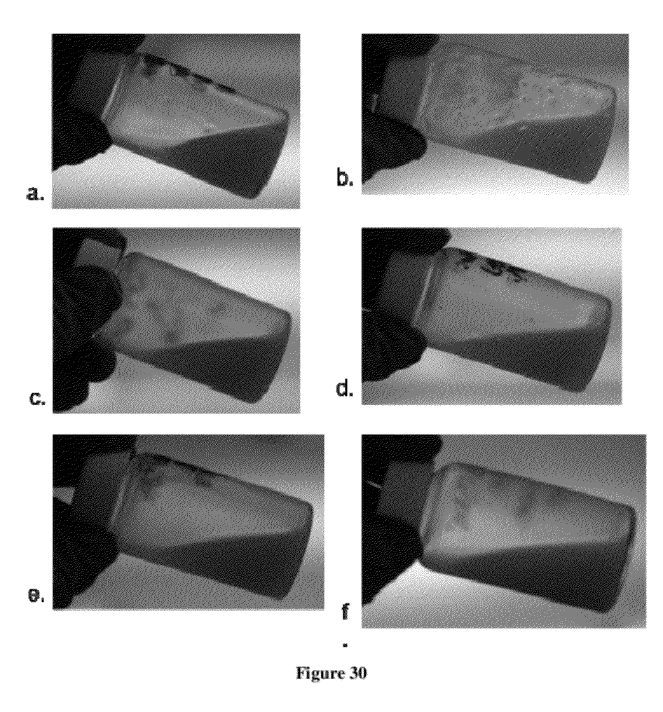

5 wt % samples of Cloisites™ in both of the ionic liquids identified above were mixed with a Thinky™ planetary mixer. Images of the solutions are shown in FIGS. 29 and 30. As can been seen in FIGS. 29 and 30, emimdcn is a better solvent that emim EtSO₄ for Cloisites™. Most of the mixtures are free of clumping and some of the emimdcn solutions (10A, 15A, 20A) are substantially optically transparent, indicating dissolution or suspension of the Cloisites™.

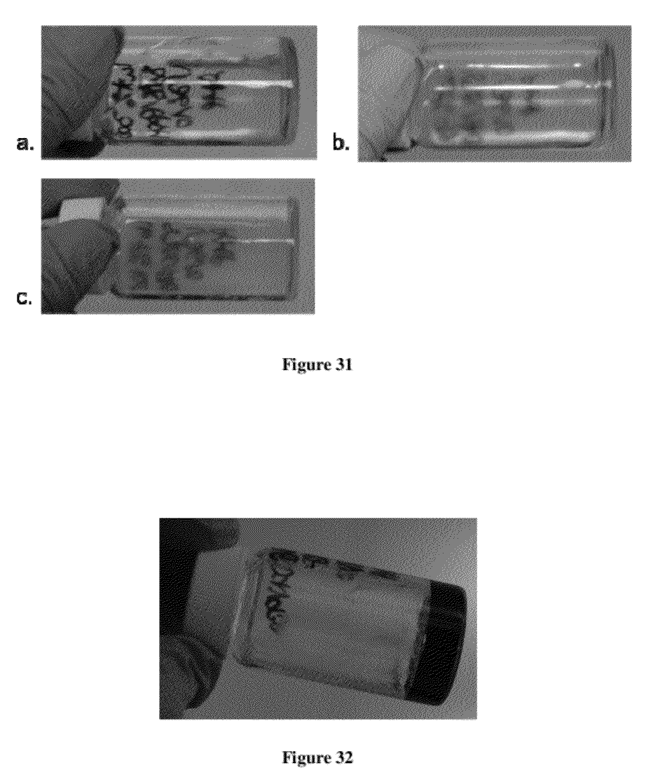

For the Cloisite™ solutions with no visible clumping, 21 wt % of the solutions (20 wt % ionic liquid, 1 wt % Cloisites™) was then added to DGEBA. For the emim EtSO₄ solutions, a stoichiometric amount of PACM was added to the Cloisite™/ionic liquid/DGEBA mixtures. All mixtures are substantially optically transparent. Although this may partially be due to the relatively low (1 wt %) Cloisite™ content, for comparison, 1 wt % mixtures of Cloisite™ in DGEBA with a stoichiometric amount of PACM were made and found to be not nearly as transparent (FIG. 31).

Samples containing emimdcn were cured by equilibrating at 80° C., followed by ramping at <1° C./min to 120° C. and curing at 120° C. for 20 minutes. Unfortunately, during cure at 120° C., all but one of the samples overheated to the point of degradation due to the high enthalpy of reaction. An image of the sample (21 wt % emimdcn/Cloisite™ 93A in DGEBA) that remained intact is shown in FIG. 32. Samples consisting of emimdcn and Cloisites™ in DGEBA that were left at ambient conditions for four months were found to have cured during that time. The functionality of the Cloisites™ appears to cause the catalysis of the reaction between emimdcn and DGEBA.

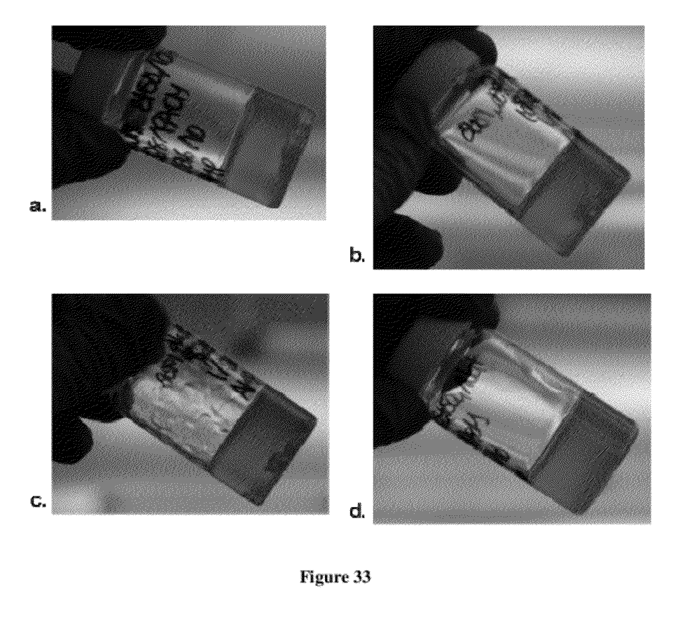

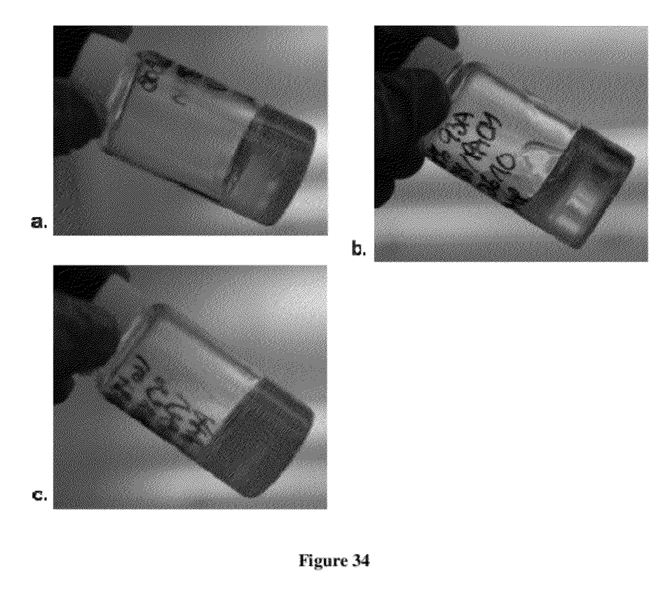

Since emim EtSO₄ does not act as a curing agent for DGEBA, the samples containing this ionic liquid were cured through a traditional epoxy-amine reaction between DGEBA and PACM. The cure cycle consisted of 2 hours at 80° C. followed by 1 hour at 165° C. FIG. 33 contains the images of the cured systems. All are homogeneous in appearance and are somewhat transparent. In comparison, the samples shown in FIG. 34 that do not contain an ionic liquid phase separate during cure to a predominantly DGEBA/PACM phase that is a solid and a predominantly Cloisite™ phase that ranges from a rubbery consistency to a liquid. It is therefore clear that the ionic liquid is necessary for and effective at dispersion of the Cloisite™ within the polymer network.

### Glass Transition Temperature

Differential scanning calorimetry was performed using a TA Instruments Q2000 DSC at a ramp rate of 10° C. min⁻¹. Tg=85.25° C. for 21 wt % Cloisite™ 93A/DCN in DGEBA and Tg=97.67° C. for 21 wt % Cloisite™ 93A/EtSO4 in DGEBA and PACM were measured.

### CONCLUSIONS

Ionic liquids are effective solvents for Cloisites™. Emimdcn can act as an effective dispersing agent as well as curing agent for epoxy systems. Since the Cloisite™ composites without ionic liquid exhibited phase separation and incomplete cure, it has been shown that ionic liquids are necessary for the homogeneity and full cure of epoxy networks containing Cloisites™.

The foregoing examples have been presented for the purpose of illustration and description only and are not to be construed as limiting the invention in any way. The scope of the invention is to be determined from the claims appended hereto.

1. A curable resin composition comprising:
(a) at least one epoxy resin;
(b) at least one ionic liquid, an adduct of an ionic liquid and an epoxy resin or a mixture thereof; and
(c) a nano-material.

2. The resin composition of claim 1, wherein said ionic liquid comprises an anion selected from the group consisting of a dicyanamide anion, an ethyl sulfate anion, halide anion and a bis(trifluoromethylsulfonyl)imide anion.

3. The resin composition as claimed in claim 2, wherein said ionic liquid comprises at least one imidazolium cation.

4. The resin composition as claimed in claim 3, wherein said ionic liquid comprises at least one dicyanimide anion or chloride anion.

5. The resin composition as claimed in claim 1, wherein component (b) is an ionic liquid.

6. The resin composition of claim 1, wherein component (b) is an adduct of an ionic liquid and an epoxy resin.

7. A nanocomposite comprising the cured product of:
(a) at least one epoxy resin;
(b) at least one ionic liquid or an adduct of an ionic liquid and an epoxy resin; and
(c) a nano-material.

8. The nanocomposite according to claim 7, wherein the nano-material is selected from the group consisting of clay, graphene, graphene oxides, graphene amides, epoxidized graphenes aminated graphenes, nano-fibers, nano-whiskers, nanotubes, nano-platelets, celluloses, metallic oxides, metallic sulfides, metallic layered hydroxides, or a mixture thereof.

9. The nanocomposite according to claim 7, wherein the nano-material is selected from carbon nanotubes, carbon nano-platelets, cellulose and clays.

10. The nanocomposite according to claim 7, wherein the nano-material comprises layered clay modified with quaternary, ternary, secondary or primary ammonium or phosphonium.

11. The nanocomposite according to claim 7, wherein the nano-material is present in an amount of from about 0.01 to about 30 volume percent based on the total volume of the nanocomposite.

12. The nanocomposite according to claim 7, wherein the amount of nano-material is from about 0.1 to about 20 volume percent based on the total volume of the nanocomposite.

13. The nanocomposite according to claim 7, wherein the amount of nano-material is from about 1 to about 15 volume percent based on the total volume of the nanocomposite.

14. The nanocomposite according to claim 7, wherein the epoxy resin is selected from the group consisting of: polyphenols, polyglycidyl ethers, glycidyl ether esters, polyglycidyl esters, epoxidated phenol-novolak resins, epoxidated cresol-novolak resins, epoxidated polyolefins, cycloaliphatic epoxy resins, alkylene oxides and urethane-modified epoxy resins.

15. The nanocomposite according to claim 7, wherein the epoxy resin is selected from the group consisting of: bisphenol A, bisphenol F, bisphenol AD, alkylene oxides, epoxidized Nafion, epoxidized biphenyls, catechol and resorcinol.

16. The nanocomposite according to claim 7, wherein the ionic liquid is liquid at a temperature below 23° C.

17. The nanocomposite according to claim 7, wherein a molar ratio of the ionic liquid per two moles of epoxy groups in the epoxy resin is from about 0.1 to about 10.

18. The nanocomposite according to claim 7, wherein a molar ratio of the ionic liquid per two moles of epoxy groups in the epoxy resin is from about 0.1 to about 1.0.

19. The nanocomposite according to claim 7, wherein component (b) is an adduct of an ionic liquid and an epoxy resin.

20. The nanocomposite according to claim 19, wherein a molar ratio of the ionic liquid per two moles of epoxy groups in the epoxy resin is from about 1.0 to about 10.

21. The nanocomposite according to claim 7, wherein component (b) is an ionic liquid.

22. A process for producing a nanocomposite comprising:
(a) selecting an epoxy resin;
(b) selecting a nano-material;
(c) selecting a type and amount of an ionic liquid based on a desired property of the polymer matrix, the property being selected from the group consisting of a physical property of the nanocomposite, a chemical property of the nanocomposite, a chemical structure of the nanocomposite, or a combination thereof; and,
(d) preparing the nanocomposite.

23. A method as claimed in claim 22, where the one or more properties of the cured product are selected from the group consisting of glass transition temperature, cross-linking density, electrical conductivity, thermal stability, specific gravity, heat capacity, electrochemical window, melting point, viscosity, density and water solubility.

24. A method as claimed in claim 22, wherein the amount of the ionic resin is employed to control one or more properties of the cured product selected from the group consisting of glass transition temperature, melting point and thermal stability.

25. The process according to claim 22, wherein the nanocomposite is formed by polymerizing the epoxy resin in the presence of the nano-material and the ionic liquid.

26. The process according to claim 22, wherein the nanocomposite is formed by polymerizing the epoxy resin in the presence of the nano-material and an adduct of the ionic liquid and the epoxy resin.
